(19) United States
(12) Patent Application Publication
(10) Pub. No.: US 2025/0047573 A1
(43) Pub. Date: Feb. 6, 2025

(54) Handling of Triggers for RAN-Visible QoE Reporting

(71) Applicant: Telefonaktiebolaget LM Ericsson (publ), Stockholm (SE)

(72) Inventors: Luca Lunardi, Genoa (IT); Ali Parichehrehteroujeni, Linköping (SE); Johan Rune, Lidingö (SE); Filip Barac, Huddinge (SE); Cecilia Eklöf, Täby (SE)

(21) Appl. No.: 18/718,533

(22) PCT Filed: Dec. 30, 2022
(86) PCT No.: PCT/SE2022/051259

§ 371 Date: Jun. 11, 2024

Related U.S. Application Data
(60) Provisional application No. 63/296,663, filed on Jan. 5, 2022.

(51) Int. Cl. H04L 41/5067; H04L 43/06

(52) U.S. Cl. CPC H04L 41/5067; H04L 43/06

(57) ABSTRACT

Embodiments include methods for a user equipment (UE) configured to perform quality-of-experience (QoE) measurements in a radio access network (RAN). Such methods include performing QoE measurements for one or more applications operating on a UE application layer and detecting occurrence of at least one event or condition that triggers a RAN-visible QoE(RVQoE) report. Such methods include, based on detecting the occurrence of the at least one event or condition, sending to a RAN node at least one RVQoE report that includes the following: one or more RVQoE metrics or RVQoE values, each based on the QoE measurements performed; and one or more trigger-related indications associated with the detected event or condition. Other embodiments include complementary methods for a RAN node as well as UEs and RAN nodes configured to perform such methods. FIG. 8 is selected for publication.

### TECHNICAL FIELD

The present disclosure relates generally to wireless communication networks, and more specifically to how a user equipment (UE) manages configured and/or ongoing application-layer (e.g., quality-of-experience or QoE) measurements in a radio access network (RAN) during handover between cells in the RAN.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. A gNB-CU connects to gNB-DUs over respective F1 logical interfaces, such as interfaces 122 and 132 shown in FIG. 1. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUs and DUs can include various circuitry needed to perform their respective functions, including processing circuitry, transceiver circuitry (e.g., for communication), and power supply circuitry.

Centralized control plane protocols (e.g., PDCP-C and RRC) can be hosted in a different CU than centralized user plane protocols (e.g., PDCP-U). For example, a gNB-CU can be divided logically into a CU-CP function (including RRC and PDCP for signaling radio bearers) and CU-UP function (including PDCP for UP). A single CU-CP can be associated with multiple CU-UPs in a gNB. The CU-CP and CU-UP communicate with each other using the E1-AP protocol over the E1 interface, as specified in 3GPP TS 38.463 (v15.4.0). Furthermore, the F1 interface between CU and DU (see FIG. 1) is functionally split into F1-C between DU and CU-CP and F1-U between DU and CU-UP. Three deployment scenarios for the split gNB architecture shown in FIG. 1 are CU-CP and CU-UP centralized, CU-CP distributed/CU-UP centralized, and CU-CP centralized/CU-UP distributed.

FIG. 2 shows another high-level view of an exemplary 5G network architecture, including an NG-RAN (299) and a 5GC (298). As shown in the figure, the NG-RAN can include gNBs (e.g., 210a,b) and ng-eNBs (e.g., 220a,b) that are interconnected with each other via respective Xn interfaces. The gNBs and ng-eNBs are also connected via the NG interfaces to 5GC 298, more specifically to access and mobility management functions (AMFs, e.g., 230a,b) via respective NG-C interfaces and to user plane functions (UPFs, e.g., 240a,b) via respective NG-U interfaces. Moreover, AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs can support the fourth generation (4G) Long-Term Evolution (LTE) radio interface but unlike conventional LTE eNBs, ng-eNBs connect to the 5GC via the NG interface. Each of the gNBs and ng-eNBs can serve a geographic coverage area including one more cells (e.g., 211a-b and 221a-b shown in FIG. 2). Depending on the cell in which it is located, a UE (e.g., 205 in FIG. 2) can communicate with the gNB or ng-eNB serving that cell via the NR or LTE radio interface, respectively. Although FIG. 2 shows gNBs and ng-eNBs separately, it is also possible that a single NG-RAN node provides both types of functionality.

Quality of Experience (QoE) measurements were specified for UEs operating in earlier-generation LTE and UMTS networks and are being specified in 3GPP for UEs operating in NR networks. Measurements in all these networks operate according to similar high-level principles, with the purpose of measuring the end-user experience for certain applications over the network. For example, QoE measurements for streaming services and for MTSI (Mobility Telephony Service for IMS) are supported in LTE and NR networks.

Radio resource control (RRC) signaling is used to configure application-layer QoE measurements in UEs and to collect QoE measurement result files from configured UEs. In particular, an application-layer measurement configuration from a core network (e.g., EPC, 5GC) or a network operations/administration/maintenance (OAM) function is encapsulated in a transparent container and sent to a UE's serving base station (e.g., eNB, gNB), which forwards it to the UE access stratum (AS) in an RRC message. Application-layer measurements made by the UE are encapsulated in a transparent container that is sent by the UE AS to the serving base station in an RRC message. The serving base station then forwards the container to a Trace Collector Entity (TCE) or a Measurement Collection Entity (MCE) associated with the CN.

In addition to conventional or legacy QoE metrics, 3GPP has agreed to support so-called “RAN-visible” (or RV, for short) QoE metrics and QoE values. In particular, RVQoE metrics are a subset of legacy QoE metrics collected from UE and RVQoE values are derived from legacy QoE metrics through a model and/or function. Both are RAN-visible because they can be useful (in some way) to the RAN (e.g., NG-RAN).

### SUMMARY

A QoE measurement report from a UE can be triggered by various conditions and/or events, which can be associated with the UE application layer or the UE AS. However, the UE AS is currently unable to inform the UE application layer that a triggering condition (or which one) for performing RVQoE measurements by the UE application layer has been fulfilled at the UE AS. Likewise, the UE application layer is currently unable to inform the UE AS that a triggering condition (or which one) has been fulfilled at the UE application layer. This can cause various problems, issues, and/or difficulties.

Embodiments of the present disclosure provide specific improvements to QoE measurements by UEs in a wireless network, such as by providing, enabling, and/or facilitating solutions to exemplary problems summarized above and described in more detail below.

Embodiments include methods (e.g., procedures) for a UE configured to perform QoE measurements in a radio access network (RAN).

These exemplary methods can include performing QoE measurements for one or more applications operating on a UE application layer. These exemplary methods can also include detecting occurrence of at least one event or condition that triggers a RAN-visible QoE (RVQoE) report. These exemplary methods can also include, based on detecting the occurrence of the at least one event or condition, sending the following to a RAN node:
at least one RVQoE report that includes one or more RVQoE metrics or RVQoE values, wherein each RVQoE metric or RVQoE value is based on QoE measurements performed by the UE; and
one or more trigger-related indications associated with the detected event or condition, included in or with each RVQoE report sent.

In some embodiments, the one or more trigger-related indications include any of the following:
indication that an RVQoE reporting trigger occurred;
indication or identifier of the RVQoE reporting trigger;
a time at which the RVQoE reporting trigger occurred;
cause or reason for occurrence of the RVQoE reporting trigger;
indication or identifier of entity that detected the RVQoE reporting trigger;
type of RVQoE reporting trigger; and
extended information associated with the RVQoE reporting trigger.

In some embodiments, the extended information includes one or more of the following: cell identifier, network slice identifier, network slice type, radio access technology (RAT) identifier, public land mobile network (PLMN) identifier, protocol data unit (PDU) session-related parameters, and respective values of one or more QoE-related parameters that caused the RVQoE reporting trigger.

In some embodiments, the at least one event or condition is related to one or more of the following:
an RVQoE reporting request from the RAN node;
a duration since last RVQoE report;
an RVQoE reporting configuration from the RAN node;
messages or control elements (CEs) sent to or received from the RAN node;
messages sent between different units of the RAN node;
one or more RAN-related events;
a UE procedure related to mobility, multi-connectivity, and/or state change;
a protocol data unit (PDU) session;
a network slice;
layer-2 and/or radio-related measurements performed by the UE;
one or more RVQoE metrics and/or RVQoE values in relation to corresponding thresholds;
service types, service subtypes, and/or subservice types of the one or more applications being measured; and
session-related events for the one or more applications being measured.

In some embodiments, these exemplary methods can also include receiving from the RAN node an RVQoE reporting request that includes one or more of the following: a request to include trigger-related indications with or in RVQoE reports; and an RVQoE reporting configuration comprising the at least one event or condition. In some of these embodiments, these exemplary methods can also include sending to the RAN node an indication of a UE capability for providing trigger-related indications in or with RVQoEreports. In such case, the request to include trigger-related indications is received responsive to the indication of the UE capability.

In some embodiments, the occurrence of the at least one event or condition is detected by a UE access stratum (AS) or the UE application layer. In some of these embodiments, performing the QoE measurements includes the UE (e.g., AS or application layer) storing the at least one RVQoE report comprising the one or more RVQoE metrics or RVQoE values that are based on the performed QoE measurements. The at least one event or condition is detected after storing the at least one RVQoE report.

In other embodiments, these exemplary methods can also include, based on detecting the at least one event or condition, the UE AS sending an RVQoE reporting request to the UE application layer and receiving, from the UE application layer, the at least one RVQoE report that includes the one or more RVQoE metrics or RVQoE values. In some variants, the RVQoE reporting request sent to the UE application layer and the at least one RVQoE report received from the UE application layer include the trigger-related indications. In other variants, these exemplary methods can also include the UE AS modifying the at least one RVQoE report received from the UE application layer to include or to associate the trigger-related indications before sending to the RAN node.

In other embodiments, the occurrence of the at least one event or condition is detected by the UE application layer and these exemplary methods also include the UE AS sending to the UE application layer an RVQoE reporting request that includes one or more of the following: a request to include trigger-related indications with or in RVQoE reports; and an RVQoE reporting configuration comprising the at least one event or condition.

In some embodiments, detecting the occurrence of the at least one event or condition includes the UE (e.g., AS or application layer) receiving from the RAN node an indication that the at least one event or condition has occurred.

Other embodiments include methods (e.g., procedures) for a RAN node configured to manage QoE measurements by UEs in a RAN.

These exemplary methods can include sending, to a UE, a RVQoE reporting request that includes one or more of the following: a request to include trigger-related indications with or in RVQoE reports, and a reporting configuration comprising at least one event or condition that triggers an RVQoE report. These exemplary methods can also include, based on occurrence of the at least one event or condition, receiving the following from the UE:
at least one RVQoE report that includes one or more RVQoE metrics or RVQoE values, wherein each RVQoE metric or RVQoE value is based on QoE measurements performed by the UE; and
one or more trigger-related indications associated with the at least one event or condition, included in or with each RVQoE report received.

In various embodiments, the one or more trigger-related indications can include any of those summarized above in relation to UE embodiments. In various embodiments, the at least one event or condition can include any of the events or conditions summarized above in relation to UE embodiments.

In some embodiments, these exemplary methods can also include receiving from the UE an indication of a UE capability for providing trigger-related indications in or with RVQoEreports. The request to include trigger-related indications is included in the RVQoE reporting request responsive to the indication of the UE capability.

In some embodiments, the at least one event or condition is detected by one of the following: the UE application layer, or the UE AS.

In other embodiments, these exemplary methods can also include detecting the occurrence of the at least one event or condition and sending to the UE an indication that the at least one event or condition has occurred. In such case, the at least one RVQoE report is received in response to sending the indication.

In some of these embodiments, the occurrence of the at least one event or condition is detected by a first unit of the RAN node and the indication is sent to the UE by a second unit of the RAN node. In addition, detecting the occurrence of the at least one event or condition includes the second unit receiving, from the first unit, the indication that the at least one event or condition has occurred (i.e., which the second unit sends to the UE). In some variants, these exemplary methods can also include the second unit sending, to the first unit, an RVQoE reporting configuration comprising the at least one event or condition (i.e., upon which the first unit bases the detection).

In different variants of these embodiments, the second unit of the RAN node is a CU-CP and one of following applies:
the first unit of the RAN node is a DU and the indication sent by the first unit is an F1AP message; or
the first unit is a CU-UP and the indication sent by the first unit is an E1AP message.

In other of these embodiments, detecting the occurrence of the at least one event or condition includes receiving an indication that the at least one event or condition has occurred, from one of the following: another RAN node, a core network (CN) node, an operations administration and maintenance (OAM) node, or a service management and orchestration (SMO) node.

In some embodiments, these exemplary methods can also include performing one or more of the following based on the received at least one RVQoE report:
managing carrier aggregation (CA) and/or dual connectivity (DC) for the UE;
scheduling and/or link adaptation for data associated with a UE application;
selecting a type of handover or other mobility operation to be performed by the UE;
evaluating a handover or other mobility operation previously performed by the UE; and
training one or more artificial intelligence/machine learning (AI/ML) models.

Other embodiments include UEs (e.g., wireless devices, etc.) and RAN nodes (e.g., base stations, eNBs, gNBs, ng-eNBs, TRPs, etc.) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

These and other embodiments described herein can facilitate a RAN node to receive UE application-related information that it can understand and use for radio network optimization tasks. Examples of RAN use cases that can benefit from such application-related information include QoE-aware traffic steering, scheduling and link adaptation, mobility-related decisions, mobility decision evaluation, and inputs to AI/ML algorithms used for network optimization and/or fault prediction.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows exemplary NR user plane (UP) and control plane (CP) protocol stacks.

FIGS. 4A-C illustrate various aspects of QoE measurement configuration for a UE in an LTE network.

FIGS. 5A-C illustrate various aspects of QoE measurement collection for a UE in an LTE network.

FIG. 6 shows a timeline of an example video-streaming session that illustrates calculation of stalling-related metrics from a Play List metric.

FIGS. 7A-B show exemplary ASN.1 data structures, according to various embodiments of the present disclosure.

FIG. 8 shows a flow diagram of an exemplary method (e.g., procedure) for a UE, according to various embodiments of the present disclosure.

FIG. 9 shows a flow diagram of an exemplary method (e.g., procedure) for a RAN node (e.g., base station, eNB, gNB, ng-eNB, etc.), according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in which functions implemented by some embodiments of the present disclosure may be virtualized.

FIG. 15 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a gNB 5G/NR network or an eNB in an LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., mobility management entity (MME), serving gateway (SGW), packet data network gateway (P-GW), etc. A core network node can also be a node that implements a particular core network function (NF), such as access and mobility management function (AMF), session management function (SMF), user plane function (UPF), service capability exposure function (SCEF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device. However, the term “node” may be limited to a particular type of node (e.g., radio access node) based on its particular characteristics in any context.
Base station: As used herein, a “base station” may comprise a physical or a logical node transmitting or controlling the transmission of radio signals, e.g., eNB, gNB, ng-eNB, en-gNB, CU/DU, transmitting radio network node, transmission point (TP), transmission reception point (TRP), remote radio head (RRH), remote radio unit (RRU), Distributed Antenna System (DAS), relay, etc.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

5G/NR technology shares many similarities with LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

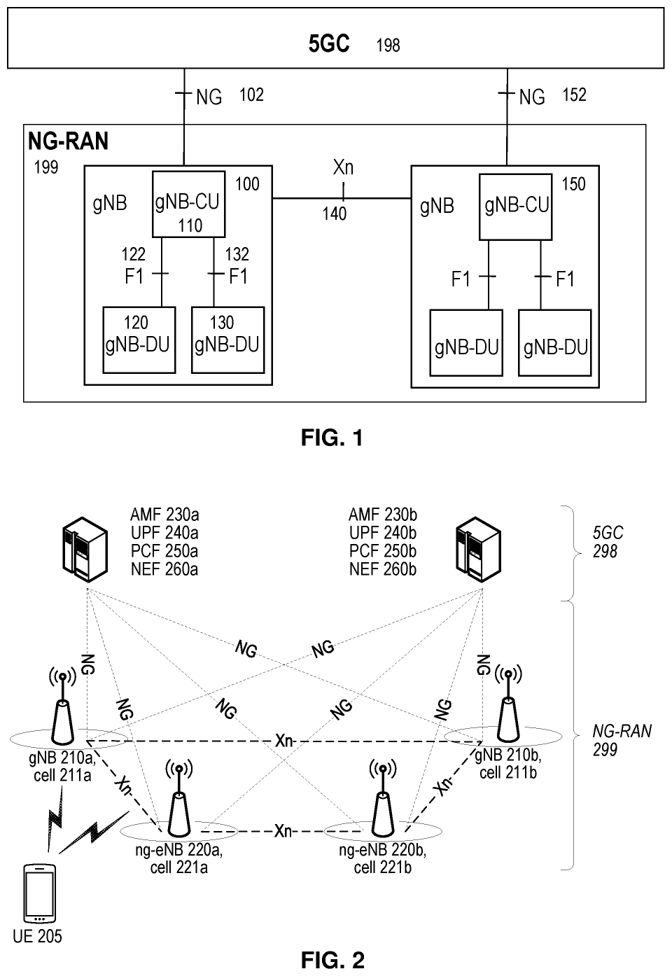

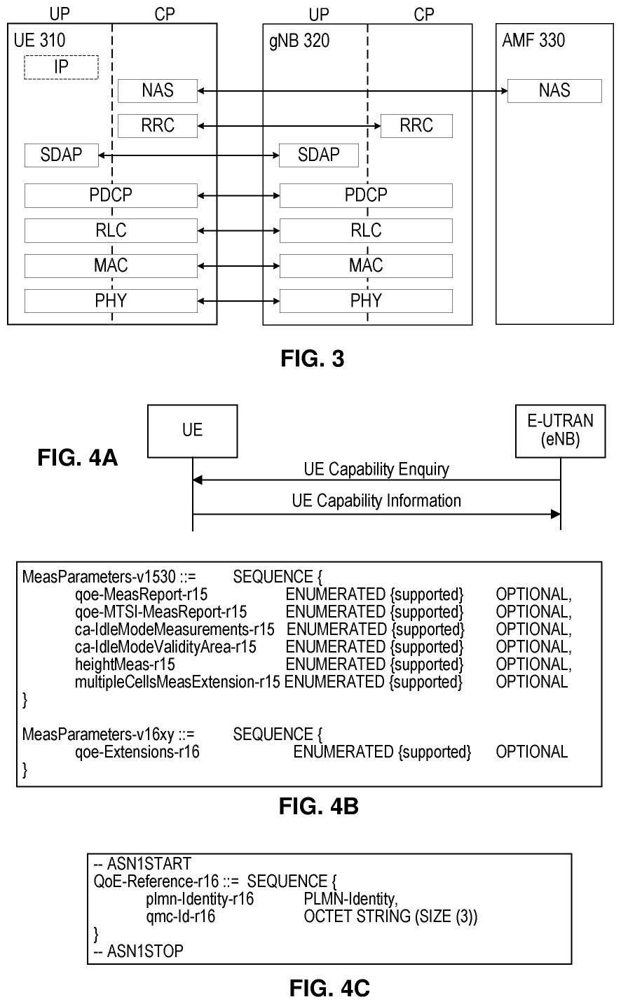

FIG. 3 shows an exemplary configuration of NR user plane (UP) and control plane (CP) protocol stacks between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

As briefly mentioned above, measurements were specified for UEs operating in earlier-generation LTE and UMTS networks and are being specified in 3GPP for UEs operating in NR networks. Measurements in all of these networks operate according to similar high-level principles, with the purpose of measuring the end-user experience for certain applications over the network. For example, QoE measurements for streaming services and for MTSI (Mobility Telephony Service for IMS) are supported in LTE and NR networks.

QoE measurements may be initiated towards the RAN from an OAM node generically for a group of UEs (e.g., all UEs meeting one or more criteria), or they may also be initiated from the CN to the RAN for a specific UE. The configuration of the measurement includes the measurement details, which is encapsulated in a container that is transparent to RAN.

A “TRACE START” S1AP message is used by the LTE EPC for initiating QoE measurements by a specific UE. This message carries details about the measurement configuration the application should collect in the “Container for application-layer measurement configuration” IE, which transparent to the RAN. This message also includes details needed to reach the TCE to which the measurements should be sent.

FIGS. 4A-C illustrate a procedure between an E-UTRAN and a UE for configuring QoE measurements in an LTE network. FIG. 4A shows an exemplary UE capability transfer procedure used to transfer UE radio access capability information from the UE to E-UTRAN. Initially, the E-UTRAN can send a UECapabilityEnquiry message. The UE can respond with a UECapabilityInformation message that includes a “UE-EUTRA-Capability” IE.

This IE may further include a UE-EUTRA-Capability-v1530 IE, which can be used to indicate whether the UE supports QoE Measurement Collection for streaming services and/or MTSI services. In particular, the UE-EUTRA-Capability-v1530 IE can include a measParameters-v1530 IE containing the information about the UE's measurement support. In some cases, the UE-EUTRA-Capability IE can also include a UE-EUTRA-Capability-v16xy-IE”, which can include a qoe-Extensions-r16 field. FIG. 4B shows an exemplary ASN.1 data structure for these various IEs, with the various fields defined in Table 1 below.

TABLE 1

| Field name | Description |
|---|---|
| qoe-MeasReport | Indicates whether the UE supports QoE Measurement Collection for |
| | streaming services. |
| qoe-MTSI-MeasReport | Indicates whether the UE supports QoE Measurement Collection for |
| | MTSI services. |
| qoe-Extensions | Indicates whether the UE supports the Rel-16 extensions for QoE |
| | Measurement Collection, i.e., support of more than one QoE |
| | measurement type at a time and signaling of withinArea, |
| | sessionRecordingIndication, qoe-Reference, temporaryStopQoE and |
| | restartOoE |
| temporaryStopQoE | Indicates that reporting, but not collection, of QoE measurements |
| | shall be temporarily stopped. |
| withinArea | Indicates at handover, for each application-layer measurement, |
| | whether the new cell is inside the area for the measurement, i.e., |
| | whether the UE is allowed to start new measurements in the cell |
| restartQoE | Indicates that QoE measurements can be reported again after a |
| | temporary stop. |

FIG. 4C shows an exemplary ASN.1 data structure for the qoe-Reference parameter mentioned in Table 1 above.

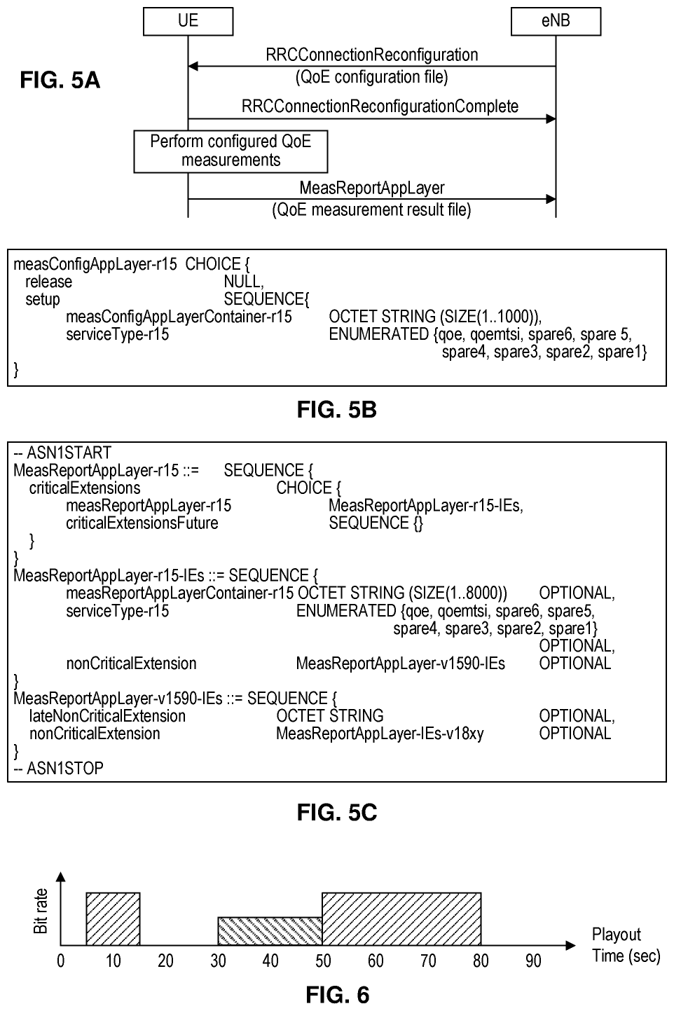

FIGS. 5A-C illustrate various aspects of QoE measurement collection for a UE in an LTE network. In particular, FIG. 5A shows an exemplary signal flow diagram of a QoE measurement collection process for LTE. To initiate QoE measurements, the serving eNB sends to a UE in RRC_CONNECTED state an RRCConnectionReconfiguration message that includes a QoE configuration file, e.g., a measConfigAppLayer IE within an OtherConfig IE. As discussed above, the QoE configuration file is an application layer measurement configuration received by the eNB (e.g., from EPC) encapsulated in a transparent container, which is forwarded to UE in the RRC message. The UE responds with an RRCConnectionReconfigurationComplete message.

Subsequently, the UE performs the configured QoE measurements and sends a MeasReportAppLayer RRC message to the eNB, including a QoE measurement result file. Although not shown, the eNB can forward this result file transparently (e.g., to EPC). More specifically, if the UE has been configured with SRB4, the UE can:
set the measReportAppLayerContainer in the MeasReportAppLayer message to the value of the application layer measurement report information;
set the serviceType in the MeasReportAppLayer message to the type of the application layer measurement report information; and
submit the MeasReportAppLayer message to lower layers for transmission via SRB4.

FIG. 5B shows an exemplary ASN.1 data structure for a measConfigAppLayer IE. The setup includes the transparent container measConfigAppLayerContainer which specifies the QoE measurement configuration for the Application of interest. In the serviceType field, a value of “qoe” indicates Quality of Experience Measurement Collection for streaming services and a value of “goemtsi” indicates Enhanced Quality of Experience Measurement Collection for MTSI. This field also includes various spare values.

FIG. 5C shows an exemplary ASN.1 data structure for a measReportAppLayer IE, by which a UE can send to the E-UTRAN (e.g., via SRB4) the QoE measurement results of an application (or service). The service for which the report is being sent is indicated in the serviceType IE.

The “UE Application layer measurement configuration” IE described in 3GPP TS 36.413 (v.16.7.0) section 9.2.1.128 carries configuration information provided by a QoE Measurement Collection (QMC) function. This IE is signaled to the RAN (eNB) from the mobility management entity (MME) in the EPC via the S1 interface CP (e.g., S1AP protocol) as further specified in 3GPP TS 36.413. In particular, this IE is included in the Trace Activation IE, which also includes the Trace Collection Entity (TCE) IP Address IE. Table 2 below defines the container for the application layer measurement configuration.

TABLE 2

| IE/Group Name | Pres. | Range | IE type/ref. | Semantics description |
|---|---|---|---|---|
| Container for | M | | Octet string | Indicates application |
| application layer | | | (1 . . . 1000) | layer measurement |
| measurement | | | | configuration, see |
| configuration | | | | Annex L in [43]. |
| CHOICE Area Scope | M | | | |
| of QMC | | | | |
| >Cell based | | | | |
| >>Cell ID List | | 1 . . . | | |
| for QMC | | <maxnoofCellIDforQMC> | | |
| >>>E-CGI | M | | 9.2.1.38 | |
| >TA based | | | | |
| >>TA List | | 1 . . . | | |
| for QMC | | <maxnoofTAforQMC> | | |
| >>>TAC | M | | 9.2.3.7 | The TAI is derived |
| | | | | using the current |
| | | | | serving PLMN. |
| >TAI based | | | | |
| >>TAI List | | 1 . . . | | |
| for QMC | | <maxnoofTAforQMC> | | |
| >>>TAI | M | | 9.2.3.16 | |
| >PLMN area based | | | | |
| >>PLMN List | | 1 . . . | | |
| for QMC | | <maxnoofPLMNforQMC> | | |
| >>>PLMN | M | | 9.2.3.8 | |
| Identity | | | | |
| Service Type | M | | ENUMERATED | This IE indicates the |
| | | | (QMC for | service type of UE |
| | | | streaming service, | application layer |
| | | | QMC for MTSI | measurements. |
| | | | service, . . .) | |

3GP-DASH profiles are defined in 3GPP TS 26.247 (v16.4.1) clause 7.3 of to enable interoperability and signaling for the use of media-related features. In general, each profile refers to a set of specific restrictions. Those restrictions can include features of a Media Presentation Description (MPD, e.g., as defined in 26.247 section 8.2), segment formats (e.g., as defined in 26.247 section 9), usage of the network, codec(s) used, content protection formats, and/or quantitative measures such as bitrates, segment lengths, screen size, etc. In particular, the following profiles are specified in 26.247:
3GPP Adaptive HTTP Streaming (Release-9 AHS);
3GP-DASH Release-10 Profile;
3GP-DASH Release 11 multi-view stereoscopic 3D video profile; and
3GP-DASH Release 11 frame-packed stereoscopic 3D video profile.

3GPP TS 26.247 also specifies that if used for TV-over-3GPP services, 3GP-DASH clients shall support the DASH features defined in 3GPP TS 26.116 (v) section 5. For 3GP-DASH clients supporting a particular continuous media types, media decoders are specified in 3GPP TS 26.234 (v) sections 7.2 (for speech), 7.3 (for audio), 7.4 (for video), 7.9 for timed text, and 7.11 (for timed graphics).

A Media Presentation Description (MPD) describes a Media Presentation, which is a bounded or unbounded presentation of media content. In particular, an MPD defines formats to announce resource identifiers for media segments and to provide the context for these identified resources within a Media Presentation. These resource identifiers are HTTP-URLs possibly combined with a byte range. 3GPP TS 26.247 (v16.4.1) section 8.4 describes the Hierarchical Data Model for DASH Media Presentation.

A Media Presentation is described in an MPD “element” that is included in an MPD “document” and consists of a sequence of one or more Periods, which can be further divided as follows:
Each Period contains one or more groups.
Each group consists of one or more Adaptation Sets.
In case an Adaptation Set contains multiple media content components, then each media content component is described individually
Each Adaptation Set contains one or more Representations
A Representation may contain one or more Sub-Representations

Adaptation Sets, Representations, and Sub-Representations share common attributes and elements that are described in 3GPP TS 26.247 (v16.4.1) section 8.4.3.2. Adaptation Sets, Representations, and Sub-Representations contain mandatory elements and attributes specified in ISO/JEC 23009-1 and may contain additional attributes and elements, as further specified in 26.247 sections 8.4.3.3-8.4.3.5. For example, an AdaptationSet element used in 3GP-DASH may contain any of the following: @minBandwidth, @maxBandwidth, @minWidth, @maxWidth, @minHeight, @maxHeight, @minFrameRate, @maxFrameRate. As another example, a Representation element used in 3GP-DASH may contain a Representation@qualityRanking and a SubRepresentation element used in 3GP-DASH may contain any of the following: SubRepresentation@level, and SubRepresentation@bandwidth

QoE metrics for Progressive Download and 3GP-DASH are specified in 3GPP TS 26.247 (v16.4.1) section 10. For example, the following metrics shall be supported by progressive download clients supporting a QoE reporting feature: Average Throughput, Initial Playout Delay, Buffer Level, Play List, and Device information. As another example, the following metrics shall be supported by 3GP-DASH clients supporting the QoE reporting feature: List of Representation Switch Events, Average Throughput, Initial Playout Delay, Buffer Level, Play List, MPD Information, and Device information.

The Buffer Level metric defines buffer level status events and is further defined in Annex D.4.5 in ISO/IEC 23009-1, according to the following table:

| Key | | Type | Description |
|---|---|---|---|
| Buffer Level | | List | List of buffer occupancy level measurements during |
| | | | playout at normal speed. |
| | Entry | Object | One buffer level measurement. |

| | | |
|---|---|---|
| t | Real-Time | Time of the measurement of the buffer level. |
| Level | Integer | Level of the buffer in milliseconds. Indicates the |
| | | playout duration for which media data of all active |
| | | media components is available starting from the |
| | | current playout time. |

Similarly, the Representation Switch Event metric is used to report a list of representation switch events that took place during the measurement interval. A representation switch event signals the client's decision to perform a representation switch from the currently presented representation to a new representation that is later presented. As part of each representation switch event, the client reports the identifier for the new representation, the (wall clock) time of the switch event when the client sends the first HTTP request for the new representation, and the media time of the earliest media sample played out from the new representation. This metric is further defined according to the following table:

| Key | | | Type | Description |
|---|---|---|---|---|
| RepSwitchList | | | List | List of Representation switch events (a switch event is |
| | | | | the time at which the first HTTP request for a new |
| | | | | Representation, that is later presented, is sent) |
| | Entry | | Object | A Representation switch event. |
| | | t | Real-Time | Time of the switch event. |
| | | mt | Media- | The media presentation time of the earliest access unit |
| | | | Time | (out of all media content components) played out |
| | | | | from the “to” Representation. |
| | | to | String | value of Representation@id identifying the switch-to |
| | | | | Representation. |
| | | lto | Integer | If not present, this metrics concerns the |
| | | | | Representation as a whole. If present, lto indicates the |
| | | | | value of SubRepresentation@level within |
| | | | | Representation identifying the switch-to level of the |
| | | | | Representation. |

Likewise, the Initial Playout Delay metric indicates the initial playout delay at the start of the streaming of the presentation. The metric is only logged at the time point when the playout of streaming video begins. This metric is further defined according to the following table:

| Key | Type | Description |
|---|---|---|
| InitialPlayoutDelay | Integer | The initial playout delay is measured as the time in |
| | | milliseconds from the fetch of the first media Segment (or |
| | | sub-segment) and the time at which media is retrieved from |
| | | the client buffer. |

Decoded samples are generally rendered in presentation time sequence, each at or close to its specified presentation time. A compact representation of the information flow can be constructed from a list of time periods during which samples of a single representation are/were continuously rendered, such that each was presented at its specified presentation time to some specific level of accuracy (e.g., +/−10 ins). A sequence of periods of continuous delivery is started by a user action that requests playout to begin at a specified media time (this could be a “play”, “seek” or “resume” action) and continues until playout stops either due to a user action, the end of the content, or a permanent failure. The Play List metric defines a sequence or list of playback periods, according to the following table:

| Key | Type | Description |
|---|---|---|
| PlayList | List | A list of playback periods. A playback period is |
| | | the time interval between a user action and |
| | | whichever occurs soonest of the next user action, |
| | | the end of playback or a failure that stops |
| | | playback. |
| Entry | Object | A record of a single playback period. |
| start | Real Time | Timestamp of the user action that starts the |
| | | playback period. |
| mstart | Media Time | The presentation time at which playout was |
| | | requested by the user action. |
| starttype | Enum | Type of user action which triggered playout |
| | | New playout request (e.g. initial playout or |
| | | seeking) |
| | | Resume from pause |
| | | Other user request (e.g. user-requested quality |
| | | change) |
| | | Start of a metrics collection period (hence earlier |
| | | entries in the play list not collected) |
| Trace | List | List of periods of continuous rendering of decoded |
| | | samples. |
| Traceentry | Objects | Single entry in the list. |
| representationid | String | The value of Representation@id from which the |
| | | samples were taken. This is an optional parameter |
| | | and should not be reported in case of progressive |
| | | download. |
| subreplevel | Integer | If not present, this metric concerns the |
| | | Representation as a whole. If present, subreplevel |
| | | indicates the greatest value of any |
| | | SubRepresentation@level being rendered. This is |
| | | an optional parameter and should not be reported |
| | | in case of progressive download. |
| start | Real Time | The time at which the first sample was rendered. |
| sstart | Media Time | The presentation time of the first sample rendered. |
| duration | Integer | The time in milliseconds of the duration of the |
| | | continuously presented samples (which is the |
| | | same in real time and media time). “Continuously |
| | | presented” means that the media clock continued |
| | | to advance at the playout speed throughout the |
| | | interval. |
| playbackspeed | Real | The playback speed relative to normal playback |
| | | speed (i.e., normal forward playback speed is 1.0). |
| stopreason | Enum | The reason why continuous presentation of this |
| | | representation was stopped. Either: |
| | | representation switch (not relevant in case of |
| | | progressive download) |
| | | rebuffering |
| | | user request |
| | | end of period |
| | | end of content |
| | | end of a metrics collection period |
| | | failure |
| | | other |
| stopreasonother | String | The stopreasonother attribute shall be included |
| | | only if stopreason attribute is included and has the |
| | | enum value other. In this release of the |
| | | specification, the sender of this string shall set its |
| | | value to one of the following: |
| | | switch from unicast to broadcast |
| | | switch from broadcast to unicast |
| | | The receiver of this attribute shall ignore this |
| | | attribute if its string is set to different value than |
| | | the values listed above. |

The “Trace” list in the table above may include entries for different representations that overlap in time because they are being rendered simultaneously, e.g., one audio and one video representation. The Play List metric includes user actions about start/stop as well as other non-user actions such as adaptation and rebuffering. Thus, the playlist may be used to derive many other metrics.

FIG. 6 shows a timeline of an example video-streaming session that illustrates calculation of stalling-related metrics from a Play List metric. Assume a user at wall-clock time hh:mm:ss=09:00:00 clicks to start a 60-second video that plays out according to the following:
5 seconds of initial stalling;
10 seconds playing with representation 1;
15 seconds of stalling;
20 seconds playing with representation 2; and
30 seconds playing with representation 1.

The playout of the 60-second video requires 80 seconds total and would result in the following (somewhat simplified) Play List metric being reported by the client:

```
Playlist
  Entry#1
    start = 09:00:00
    mstart = 00:00:00
    starttype = New playout request
    Trace
      Traceentry#1
        representationid = 1
        start = 09:00:05
        sstart = 00:00:00
        duration = 10 seconds
        stopreason = rebuffering
      Traceentry#2
        representationid = 2
        start = 09:00:30
        sstart = 00:00:10
        duration = 20 seconds
        stopreason = representation switch
      Traceentry#3
        representationid = 1
        start = 09:00:50
        sstart = 00:00:30
        duration = 30 seconds
        stopreason = end of content
```

The number of stalling occurrences may be calculated from the above Play List metric by counting how many times a stop reason is specified as “rebuffering”. The time duration for a stalling event may be calculated based on the time difference between the end time of a trace entry with stopreason equal to “rebuffering”, and the start time of the next trace entry. In the example above the stalling starts at “Traceentry #1, (start+duration)”=09:00:05+10 secs=09:00:15, and ends at “Traceentry #2, start”=09:00:30. The length of the stalling is 15 seconds.

The MPD Information metric can be used to report Representation information from the MPD, so that reporting servers without direct access to the MPD can understand the used media characteristics. This metric is reported whenever the client sends any other quality metrics report containing references to a Representation having MPD information that has not yet been reported. The table below defines the MPD Information for quality reporting.

| Key | | Type | Description |
|---|---|---|---|
| MPDInformation | | Object | |
| | representationid | String | Value of Representation@id for the |
| | | | representation addressed by the QoE metrics |
| | | | report. |
| | subreplevel | Integer | If present, value of SubRepresentation@level |
| | | | for the subrepresentation addressed by the |
| | | | QoE metrics report. If not present, the QoE |
| | | | metrics report concerns the representation as a |
| | | | whole. |
| | Mpdinfo | RepresentationType | Provides the MPD information for the |
| | | | representation or subrepresentation identified |
| | | | by representationid and subreplevel, if present. |
| | | | The following attributes and elements shall be |
| | | | present within mpdinfo if they are present for |
| | | | the identified representation or |
| | | | subrepresentation and their values shall be |
| | | | identical to those presented in the MPD: |
| | | | @bandwidth, @qualityRanking, @width, |
| | | | @height, @mimeType, and @codecs. |

The Average Throughput metric indicates the average throughput observed by the client during the measurement interval and is defined according to the table below.

| Key | | Type | Description |
|---|---|---|---|
| AvgThroughput | | Object | Average throughput that is observed by the client |
| | | | during the measurement interval |
| | numbytes | Integer | The total number of the content bytes, i.e. the total |
| | | | number of bytes in the body of the HTTP responses, |
| | | | received during the measurement interval. |
| | activitytime | Integer | The activity time during the measurement interval in |
| | | | milliseconds. The activity time during the measurement |
| | | | interval is the time during which at least one GET |
| | | | request is still not completed (i.e. excluding inactivity |
| | | | time during the measurement interval). |
| | t | Real Time | The real time of the start of the measurement interval |
| | duration | Integer | The time in milliseconds of the measurement interval |
| | accessbearer | String | Access bearer for the TCP connection for which the |
| | | | average throughput is reported |
| | inactivitytype | Enum | Type of the inactivity, if known and consistent |
| | | | throughout the reporting period: |
| | | | User request (e.g. pause) |
| | | | Client measure to control the buffer |
| | | | Error case |

The Playout Delay for Media Start-up metric indicates the waiting time that the user experiences for media start-up. This metric is only logged at the time point when the media start-up happens and is defined according to the table below.

| Key | Type | Description |
|---|---|---|
| PlayoutDelayforMediaStartup | Integer | The playout delay for media start-up is measured as |
| | | the time in milliseconds from the time instant of |
| | | DASH player receives play-back-start trigger to the |
| | | instant of media playout. |
| | | If the MPD has been delivered earlier before |
| | | the user clicks, it may include the process time |
| | | of MPD, the fetch time of some media |
| | | segments which are required for media |
| | | presentation, the process time of segments, and |
| | | the time for media decode and render to the |
| | | user. |
| | | If no MPD has been fetched earlier, it also |
| | | needs to add the fetch time of MPD. |

The Device Information metric contains information about the displayed video resolution as well as the physical screen characteristics. If the video is rendered in full-screen mode, the video resolution usually coincides with the characteristics of the full physical display. If the video is rendered in a smaller sub-window, then the characteristics of the actual video window are logged. If known by the DASH client, the physical screen width and the horizontal field-of-view shall also be logged. This metric is logged at the start of each QoE reporting period, and whenever the characteristics changes during the session (for instance if the UE is rotated from horizontal to vertical orientation, or if the video sub-window size is changed). This metric is defined according to the table below, where individual metrics that can't be logged being set to zero (0) values.

| Key | | Type | Description |
|---|---|---|---|
| DeviceInformationList | | List | A list of device information objects. |
| | Entry | Object | A single object containing new device information. |

| | | |
|---|---|---|
| start | Real- | Timestamp when the device information |
| | Time | was logged. |
| mstart | Media- | Presentation time at which the device information |
| | Time | was logged. |
| videoWidth | Integer | Width of the displayed video, in screen pixels (not |
| | | encoded video pixels). |
| videoHeight | Integer | Height of the displayed video, in screen pixels (not |
| | | encoded video pixels) |
| screenWidth | Integer | Total width of the screen, in screen pixels |
| screenHeight | Integer | Total height of the screen, in screen pixels |
| pixelWidth | Float | Width of a screen pixel, in mm |
| pixelHeight | Float | Height of a screen pixel, in mm |
| fieldOfView | Float | Actual or estimated horizontal angle subtended at the |
| | | eye by the screen, measured in degrees. |

The VR (virtual reality) Device Information metric contains information about the device and is logged at the start of each session and whenever changed (e.g., if device's rendered field-of-view is adjusted). This metric is defined according to the table below, where individual metrics that can't be logged being set to zero (0) values or to the empty string, according to metric type.

| Key | | Type | Description |
|---|---|---|---|
| VrDeviceInformation | | List | A list of device information objects. |
| | Entry | Object | A single object containing new device |

| | | |
|---|---|---|
| | | information. |
| start | Real- | Wall-clock time when the device information was |
| | Time | logged. |
| mstart | Media- | Presentation time at which the device information |
| | Time | was logged. |
| deviceIdentifier | String | Brand, model and version of the device. |
| horizontalResolution | Integer | Horizontal display resolution, per eye, in pixels. |
| verticalResolution | Integer | Vertical display resolution, per eye, in pixels. |
| horizontalFoV | Integer | Maximum horizontal field-of-view, per eye, in |
| | | degrees. |
| verticalFoV | Integer | Maximum vertical field-of-view, per eye, in |
| | | degrees. |
| renderedHorizontalFoV | Integer | Current rendered horizontal field-of-view, per eye, |
| | | in degrees. |
| renderedVerticalFoV | Integer | Current rendered vertical field-of-view, per eye, in |
| | | degrees. |
| refreshRate | Integer | Display refresh rate, in Hz |

U.S. App. 63/092,984 by the present Applicant discloses “lightweight” QoE measurements and various techniques for transmitting, receiving, and using the same. In particular, lightweight QoE measurements can be obtained by converting one or more QoE measurements logged in a conventional (or legacy) format into one or more lightweight QoE metrics. For example, each lightweight QoE metric can represent of one of the following:
a conventional QoE metric;
a plurality of different conventional QoE metrics for one application;
a plurality of different lightweight QoE metrics for one application;
respective values of a conventional QoE metric for a plurality of applications, and
respective values of a lightweight QoE metric for a plurality of applications.

Each representation used by a lightweight QoE metric can be a concatenation, an index, a score, a rating based on enumerated values, a binary relation to a threshold, etc. Each conventional QoE metric represented by a lightweight QoE metric can relate to one or more of the following characteristics:
throughput per TCP socket or per access bearer, (e.g., average, max/min, standard deviation, etc.);
end to end latency (e.g., average, max/min, standard deviation, etc.);
round trip time (e.g., average, max/min, standard deviation, instant value, etc.);
uplink delay (e.g., average, max/min, standard deviation, instant value, etc.); downlink delay (e.g., average, max/min, standard deviation, instant value, etc.);
jitter of arriving packets (e.g., average, max/min, standard deviation, instant value, etc.);
number of consecutive failures in receiving the packets (e.g., average, max/min, standard deviation, instant value, etc.);
initial playout delay;
timeliness of the packets (e.g., average, max/min, standard deviation, instant value, etc.);
application level buffer (e.g., average, max/min, standard deviation, instant value, etc.).

There are various ways to derive lightweight QoE metrics, and lightweight QoE metrics can be derived from a single conventional QoE metric or from multiple (e.g., all) conventional QoE metrics for an application. An example of the former is a lightweight representation of the average throughput (AvgThroughput) conventional QoE metric and a lightweight representation of the initial playout delay (InitialPlayoutDelay) conventional QoE metric for Progressive Download and DASH. An example of the latter is a lightweight QoE metric that represents both of these conventional QoE metrics. As another example, different subsets of conventional QoE metrics for an application can be represented by respective lightweight QoE metrics. Each subset can include one or more conventional QoE metrics.

In addition to conventional or legacy QoE metrics, 3GPP has agreed to support so-called “RAN-visible” (or RV, for short) QoE metrics and QoE values. In particular, RVQoE metrics are a subset of legacy QoE metrics collected from UE and RVQoE values are derived from legacy QoE metrics through a model and/or function. Both of these are RAN-visible because they are useful (in some way) to the RAN (e.g., NG-RAN). RVQoE metrics and values can be considered a form of lightweight QoE metrics previously disclosed by Applicant in U.S. App. 63/092,984.

A QoE measurement report from a UE can be triggered by various conditions and/or events, which can be associated with the UE application layer or the UE AS. However, the UE access stratum (AS, e.g., RRC layer) is currently unable to inform the UE application layer that a triggering condition (or which one) for performing RVQoE measurements by the UE application layer has been fulfilled at the UE AS. Likewise, the UE application layer is currently unable to inform the UE AS that a triggering condition (or which one) has been fulfilled at the UE application layer. This can cause various problems, issues, and/or difficulties.

Accordingly, embodiments of the present disclosure provide flexible and efficient techniques that enable a RAN node to receive indications about triggers (e.g., events or conditions) that caused a UE AS and/or a UE Application Layer to send one or more RVQoE metrics and/or one or more RVQoE values to the RAN node. For example, such indication(s) can be within or associated with an RVQoE report and can indicate what event or condition caused the sending of the RVQoE report. Other embodiments include indications (e.g., AT commands) by which the UE AS can inform the UE application layer that a condition for sending a RVQoE report has been fulfilled.

In this manner, embodiments can facilitate a RAN node to receive application-related information (e.g., cause or trigger of a UE RVQoE report) that it can understand (i.e., that is “visible” to the RAN node) and use for radio network optimization tasks. Examples of RAN use cases that can benefit from such application-related information include:
QoE-aware traffic steering, e.g., managing carrier aggregation (CA) and dual connectivity (DC) for a UE based on the observed/predicted QoE.
Scheduling and link adaptation, e.g., by RAN node responsive to an indication of video stalling and/or low buffer level.
Mobility-related decisions, e.g., deciding whether to use legacy handover (HO), conditional HO, or dual-active protocol stack (DAPS) HO based on the buffer level.
Mobility decision evaluation, e.g., a target RAN node sending a post-HO RVQoE report to a source RAN node for evaluation.
Using RVQoE reports as input features to artificial intelligence/machine learning (AI/ML) algorithms, e.g., for training and/or inference.

In the following description of embodiments, the following groups of terms and/or abbreviations have the same or substantially similar meanings and, as such, are used interchangeably and/or synonymously unless specifically noted or unless a different meaning is clear from a specific context of use:
“application layer” and “UE application layer” (RAN nodes generally do not have an application layer);
“application-layer measurement”, “application measurement”, and “QoE measurement”;
“QoE measurement report”, “QoE report”, “measurement report”, and “report”;
“QoE measurement configuration”, QoE measurement and reporting configuration”, “QoE measurement”, “QoE configuration”, and “application layer measurement configuration”;
“modem”, “radio layer”, “radio network layer”, “access stratum”, and “AS”;
“radio layer connection” and “RRC connection”;
“UE RRC configuration”, “RRC configuration”, “UE RRC context”, “RRC context”, “context”;
“service” and “application”;
“subservice type” and “service subtype”;
“measurement collection entity”, “MCE”, “trace collection entity”, and “TCE”.

The term “RAN visible QoE” (or “RVQoE”) may refer to RAN visible QoE measurements, RAN visible QoE measurement reporting, RAN visible QoE parameters and metrics, processing of information to derive RAN visible QoE parameters/metrics/information/data, and an overall framework for these and related activities. The term “RVQoE report” refers to a QoE report that includes RVQoE metrics and/or RVQoE values. An RVQoE report can be associated with one or more service types, one or more network slices, one or more service subtypes, one or more subservice types, etc.

As used herein, the term “conventional QoE metric” (or “legacy QoE metric”) refers to any of the QoE measurements specified in 3GPP TS 26.247 (v16.4.1), 26.114 (v16.7.0), 26.118 (v16.0.2), and 26.346 (v16.6.0) that are delivered from the UE to a network entity via the RAN, particularly when the RAN is unable to read the QoE reports containing the measured values of these metrics.

In contrast, the RAN is able to read, decode, understand, and/or interpret RVQoE metrics and/or RVQoE values included in QoE reports. The RVQoE metrics and values can be carried in information elements (IEs) of protocol messages, including RRC and inter-node signaling protocols. RVQoE metrics and values can be representations (e.g., in modified, adapted, or otherwise processed forms) of at least one conventional (or legacy) QoE metric as that term is defined above. Each representation can be condensed, compact, simplified, and/or more abstract with respect to the conventional QoE metric(s). For each, a RVQoE metric or value can require fewer information bits to transmit than corresponding conventional QoE metric(s).

Although embodiments are sometimes described below in the context of streaming services, they are equally applicable to other types of services such as services whose QoE metrics are a subset of, a superset of, or different than the QoE metrics defined for the streaming service

In some embodiments, a RAN node determines or receives from another network node (e.g., RAN node, CN node, OAM node, SMO node, etc.) one or more triggers for RVQoE reports that will be used for RAN optimization purposes. The RAN node sends to a UE (i.e., to the UE AS or to the UE application layer via the UE AS) the one or more triggers, which are used by the UE AS and/or the UE application layer to determine when to send RVQoE reports (as that term is defined above).

In some embodiments, the RAN node can forward the one or more triggers to a second RAN node. This can be done, for example, in conjunction with handover of the UE from a cell served by the RAN node (as source node) to a cell served by the second RAN node (as target node). The second RAN node can provide the triggers to the UE in the same manner as described above.

Non-limiting examples of triggers for RVQoE reporting include any of the following, as well as any logical combination thereof (e.g., AND, OR, etc.):
a periodic request for RVQoE reporting;
a one-time request for RVQoE reporting (polling);
detection of RAN-related events;
execution/triggering of RAN-related procedures;
values or range of values for layer 2 measurements (e.g., as defined in 3GPP TS 38.314);
values or range of values for radio measurements (e.g., RSRP, RSRQ, SINR);
values of a QoE metric or value for one or more of the parameters within a QoE metric (e.g., in relation to a threshold);
values or range of values for “RVQoE metric” (e.g., in relation to a threshold);
values or range of values for “RVQoE values” (e.g., in relation to a threshold);
sending/receiving RAN protocol messages;
setting up/releasing/modifying PDU Session and/or QoS parameters;
setting up/releasing/modifying/using network slices;
setting up/releasing/modifying/using private networks;
sending/receiving/modifying QoE configurations;
sending/receiving/pausing/resuming/delaying QoE reports;
elapsed time since the last RVQoE report was sent, or since the application session started;
detection of application/application layer related events based on QoE metrics/parameters;
detection of application/application layer related events based on RVQoE metrics/parameters;
detection of application/application layer related events based on RVQoE values;
sending/receiving application related messages/indications/commands;
the UE moving to/from a certain area (e.g., UE enters a certain cell or geographical area or a Tracking Area or a PLMN);
mobility event (including handover between cells, cell selection, cell reselection, etc.);
activation/deactivation/use of unlicensed/shared spectrum (e.g., NR-U);
activation/deactivation/use of Time Sensitive Communication (TSC) or Time Sensitive Networking (TSN);
activation/deactivation/use of certain testing conditions (e.g., use of A/B testing);
activation/deactivation/use of multi-connectivity (e.g., CA and/or DC);
activation/deactivation/use of specific service types, service subtypes, subservice types (e.g., use of VR streaming);
events triggering conditional reconfiguration and execution of conditional reconfiguration;
any newly defined event/trigger.

RAN-related events triggering RVQoE reporting can be any or a combination of RRC protocol events such as defined in 3GPP TS 38.331 (v16.7.0) for NR or in 3GPP TS 36.331 (v16.7.0) for E-UTRA/LTE, including:
A1 (serving cell becomes better than threshold);
A2 (serving cell becomes worse than threshold);
A3 (neighbor cell becomes offset better than SpCell);
A4 (neighbor cell becomes better than threshold);
A5 (SpCell becomes worse than threshold1 and neighbor cell becomes better than threshold2);
A6 (neighbor cell becomes offset better than SCell);
B1 (inter-RAT neighbor cell becomes better than threshold);
B2 (PCell becomes worse than threshold1 and inter-RAT neighbor cell becomes better than threshold2);
I1 (interference becomes higher than threshold);
C1 (NR sidelink channel busy ratio is above a threshold);
C2 (NR sidelink channel busy ratio is below a threshold);
Any other newly defined RAN-related event and/or RRC event.

RAN-related procedures or RAN protocol messages triggering RVQoE reporting can be any of the following, including any combination:
RRC procedures or messages as defined in 3GPP TS 38.331 (v16.7.0) for NR or in 3GPP TS 36.331 (v16.7.0) for E-UTRA/LTE, such RRC Request, RRC Reconfiguration, RRC Resume Request, RRC Reestablishment Request, etc.;
HO, Conditional HO, DAPS HO, including any form such as intra-cell, intra-node, inter-node, intra-frequency, inter-frequency, inter-RAT, inter-system, etc.;
Cell Change, PSCell change, Conditional PSCell change;
RRC state change, such as transitioning between any two of RRC_IDLE, RRC_INACTIVE, and RRC_CONNECTED;
(re)selection of a private network;
accessing or using resources of a first network slice or reconfiguring from a first network slice to a second network slice;
accessing or releasing the NR-U resources;
use of a specific MAC control element (CE);
procedures or messages defined for multi-connectivity operation in 3GPP TS 37.340 (v16.8.0), such as SN addition, SN Modification (MN/SN initiated), SN Release (MN/SN initiated), SN Change (MN/SN initiated), PSCell change, inter-MN handover with/without SN change, MN to eNB/gNB Change, eNB/gNB to MN change, etc.

Layer-2 measurements triggering RVQoE reporting can include values (e.g., thresholds) or range of values for one or more measurements defined in 3GPP TS 38.314. Such layer-2 measurements can include various measurements performed at a RAN node, including:
RAN portion of DL Packet delay, or one or more components thereof (e.g., DL delay over the air interface);
RAN portion of UL packet delay, or one or more components thereof (e.g., UL PDCP packet average delay, average RLC packet delay, average over the air delay, etc.);
DL Packet Loss Rate; and
PRB usage for MIMO.
   Such layer-2 measurements can also include various measurements performed and reported by a UE such as UL Packet Delay.

Application-related events based on QoE-related parameters used as triggers for RVQoE reporting can be defined based on one or more of the following, including any logical combination thereof (e.g., AND, OR, etc.): one or more QoE metrics, one or more RVQoE metrics, and/or one or more RVQoE values. To provide more specific examples, application-related events based on QoE-related parameters used as triggers for RVQoE reporting can be based on one or more of the following, including any logical combination thereof:
termination of a session (normal or abnormal)
a QoE metric assuming a value above a first threshold, below the first threshold, between the first threshold and a second threshold, below a first (lower) threshold or above a second (higher) threshold, etc. As a more specific example, the UE application layer can be triggered to report InitialPlayoutDelay before session end when InitialPlayoutDelay is above a first threshold.
detection of one or more QoE parameters (or parts of QoE metrics). As one example, the UE application layer can be triggered to report detection of a stop in a representation of a streaming due to rebuffering or video stalling. As another example, the UE application layer can be triggered to report the number of stops in a representation of a streaming due to rebuffering during a session.
one or more QoE parameters (or parts of QoE metrics) assuming values above a first threshold, below the first threshold, between the first threshold and a second threshold, below a first (lower) threshold or above a second (higher) threshold, etc. As one example, the UE application layer can be triggered to report detection of a level of the buffer in milliseconds—as part of the Buffer Level—that exceeds a threshold.

Any of the above examples can be modified to be based on RVQoE-related parameters rather than QoE-related parameters. Furthermore, application related messages/indications/commands used as triggers for RVQoE reporting can be one or more of the following, including any logical combination thereof:
Session Start indication or a Session Stop indication;
pause in QoE reporting; and
resumption of QoE reporting.

In various embodiments, trigger-related indications for RVQoE reporting can include one or more of the following:
indication that a RVQoE reporting trigger has occurred (e.g., flag, Boolean, etc.);
timestamp (e.g., time at which a RVQoE reporting trigger occurred);
cause or reason for occurrence of a RVQoE reporting trigger (e.g., enumerated value);
indication or identifier of an entity that determined the trigger occurred (e.g., UE AS, UE application layer, RAN node, CN node, OAM node, SMO node, etc.).
RVQoE reporting trigger type (e.g., which of multiple configured trigger events or conditions, represented as an index or an enumerated value);
indication of which RVQoE reporting trigger(s) has(have) occurred (e.g., RAN-related event, MR-DC procedure, mobility event, HO preparation, HO execution, use or selection of a specific RAT), represented as an index or an ENUMERATED value
extended information concerning one or more RVQoE reporting triggers.

In one example, a DU can determine that a particular trigger has occurred and inform the CU-CP about it. Based on this, the CU-CP sends to the UE AS (or to the UE application layer via the UE AS) a request (e.g., a poll) to obtain RVQoE report(s) and to include in the RVQoE report(s) indications that the reporting is caused by a DU-detected trigger.

In another example, a RAN node configured as a UE's secondary node (SN) in MR-DC determines that a particular trigger has occurred and informs the UE's master node (MN) about it. Based on this, the MN sends to the UE AS (or to the UE application layer via the UE AS) a request (e.g., a poll) to obtain RVQoE report(s) and to include in the RVQoE report(s) indications that the reporting is caused by an SN-detected trigger.

In another example, extended information for a RAN-related event can include an indication of a specific RRC event (e.g., A3, A5, B2, etc.), identifier(s) or cells (e.g., NR CGIs) and/or carrier frequencies involved in the event, etc. In another example, extended information pertaining to PDU Session and/or QoS parameters can include PDU Session parameters (e.g., PDU Session Identity), QoS Flow parameters (e.g., QoS Flow Identifier, 5QI, Guaranteed Bit Rate UL/DL, etc.), DRB parameters (e.g., DRB identity), SRB parameters (e.g., SRB identity), etc.

In another example, extended information pertaining to network slices can include network slice identifier(s), type(s) of network slices (e.g., Allowed NSSAI, Target NSSAI), inclusion or exclusion of one or more S-NSSAIs in QoE Area scope, etc. In another example, extended information can include use of a specific RAT, use of a specific PLMN, etc. In another example, extended information can include an actual value of a parameter or metric whose relation to a threshold triggered sending the RVQoE report. In another example, extended can include previous and/or historical values of a parameter or metric whose relation to a threshold triggered sending the RVQoE report

In some embodiments, a RAN node requests UE AS or UE application layer (via the UE AS) to send trigger-related indications for RVQoE reporting together with or as part of one or more RVQoE reports. The RAN node can then receive from the UE AS trigger-related indications for RVQoE reporting together with or as part of the requested RVQoE report(s).

In some embodiments, a RAN node may receive from another network node (such as another RAN node, a CN node, an OAM node, or an SMO node) an indication that an event has occurred, or that a condition has been fulfilled, that should trigger a RVQoE report to be sent by a UE. As another option, a RAN node may receive from the other network node a request to obtain a RVQoE report from the UE. Upon receiving such an indication or request the RAN node may request the UE to send a RVQoE report. The request may be made by sending a message to the UE AS or to the UE application layer via the UE AS.

In some embodiments, a RAN node may request the UE AS to indicate whether it supports providing trigger-related indications together with or as part of RVQoE reports.

In some embodiments, the first unit of a RAN node may receive indications from one or more other units of the RAN node and based on such information, send a request for a UE AS and/or a UE application layer to report (e.g., together with or as part of RVQoE reports) one or more indications about trigger(s) that caused the RVQoE reporting.

For example, the CU-CP (e.g., of a gNB or eNB) may receive from a DU or a CU-UP (e.g., of the same gNB or eNB) an indication of an event or a condition that should trigger a RVQoE report by a UE. Upon reception this information the CU-CP can send a message to the UE AS (or via the UE AS to the UE application layer) that requests the UE to send an RVQoE report. Furthermore, the DU or CU-UP may detect occurrence of the event and send the indication responsive to the detection. In some variants, the CU-CP may instruct the DU or CU-UP to indicate to the CU-CP when the event has occurred that should trigger a RVQoE report to be sent by the UE. In some further variants, the CU-CP may configure the DU or CU-UP with these events and/or conditions.

In some embodiments, after receiving such an indication from a DU or a CU-UP, the CU-CP may request the DU or CU-UP to send an indication of which (or which type of) event or condition that was detected (unless this was already included in the indication that the event had occurred or that the condition had been fulfilled).

As non-limiting examples, a CU-CP may decide to request from a UE trigger-related indications for RVQoE reports and/or for specific RVQoE metrics or values, based on occurrence of particular events on the E1AP interface or the F1AP interface. Some examples are given below:
CU-CP receives from CU-UP an E1AP GNB-CU-UP STATUS INDICATION message to inform the CU-CP that the CU-UP is overloaded so that overload reduction actions can be applied, as specified in 3GPP TS 38.463 (v16.7.0) section 8.2.8.
CU-CP receives from CU-UP an E1AP RESOURCE STATUS UPDATE message to inform the CU-CP of results of the admitted measurements, as specified in 3GPP TS 38.463 (v16.7.0) section 8.2.10, and the load measurements indicate that one or more load metrics are above (or below) a first threshold or between the first threshold and a second threshold.
CU-CP receives from CU-UP an E1AP DL DATA NOTIFICATION message to indicate DL data arrival for the UE or that a DL packet is received with the QoS characteristics specified in 3GPP TS 38.463 (v16.7.0) section 8.3.7.
CU-CP receives from CU-UP an E1AP DATA USAGE REPORT message report data volume served at the CU-UP as specified in 3GPP TS 38.463 (v16.7.0) section 8.3.8.
CU-CP receives from CU-UP an E1AP UL DATA NOTIFICATION message to indicate the reception of an UL packet with the QoS characteristics specified in 3GPP TS 38.463 (v16.7.0) section 8.3.10.
CU-CP receives from CU-UP an E1AP MR-DC DATA USAGE REPORT message to report data volume served at the CU-UP as specified in 3GPP TS 38.463 (v16.7.0) section 8.3.11.
CU-CP receives from DU an F1AP RESOURCE STATUS UPDATE message to inform the CU-CP of results of the admitted measurements, as specified in 3GPP TS 38.463 (v16.7.0) section 8.2.11, and the load measurements indicate that one or more load metrics are above (or below) a first threshold or between the first threshold and a second threshold.
CU-CP receives from DU an F1AP ACCESS SUCCESS message informing the CU-CP of which cell the UE successfully accessed during conditional HO or conditional PSCell change as specified in 3GPP TS 38.463 (v16.7.0) section 8.3.8.

In some embodiments, the triggers for RVQoE reporting can be determined and/or detected by the UE AS. In such embodiments, the UE AS receives from a RAN node a configuration that includes one or more triggers (i.e., associated with events or conditions) for RVQoE reporting.

In some of these embodiments, upon occurrence of an event or condition associated with a configured trigger, the UE AS requests the UE application layer to provide one or more RVQoE reports for sending by the UE AS to RAN. The UE AS also includes trigger-related indications with or in these RVQoE reports.

In some of these embodiments, upon occurrence of an event or condition associated with a configured trigger, the UE AS requests the UE application layer to provide one or more RVQoE metrics and/or RVQoE values. For example, the UE AS sends AT command(s) to the UE application layer for this purpose. In addition, one of the following can happen:
UE AS also sends to the UE application layer trigger-related indications associated with the event or condition that has occurred, and requests the UE application layer to include one or more of such indications in RVQoE report(s) provide by the UE application layer to the UE AS. The trigger-related indications can be sent in the same instruction/command or in a different instruction/command as the request.
UE AS receives from the UE application layer RVQoE report(s) and forwards these to the RAN node, with trigger-related indications included with or in the RVQoE report(s). For example, the UE AS may modify the received RVQoE report(s) to include the trigger-related indications within.

As one example of such embodiments, the UE AS requests the UE application layer to provide application-layer buffer level information when a radio-related event (e.g., A3 event) is detected at the UE AS, and to include as part of the RVQoE report trigger-related indication(s) associated with the A3 event (e.g., trigger event, trigger type, timestamp, etc.).

In other embodiments, upon occurrence of an event or condition associated with a configured trigger, the UE AS sends to the RAN node RVQoE reports already available (e.g., stored) at UE AS, with trigger-related indications included with or in the RVQoE report(s). For example, the UE AS may modify the received RVQoE report(s) to include the trigger-related indications within.

As one example of such embodiments, the UE AS sends to the RAN node an available (e.g., previously generated and stored) RVQoE report that contains an RVQoE metric indicating application-layer buffer level information for a streaming service. The sending is triggered by occurrence of a radio related event (e.g., A3) as detected by the UE AS. The UE AS also sends to the RAN node as part of the RVQoE report trigger-related indication(s) associated with the A3 event (e.g., trigger event, trigger type, timestamp, etc.).

In some embodiments, triggers for RVQoE reporting can be determined and/or detected by the UE application layer. In such embodiments, the UE AS receives from a RAN node a configuration that includes one or more triggers (i.e., associated with events or conditions) for RVQoE reporting. The UE AS provides this configuration to the UE application layer, e.g., together with or separate from a request to provide trigger-related information for RVQoE reports generated based on the configuration. Alternately, the UE AS derives from the configuration instructions, commands, etc. that are relevant to the UE application layer, and then provides the derived information to the UE application layer. As an implementation example, the configuration, derived information, etc. can be sent by the UE AS with an AT command.

Subsequently, the UE AS receives from the UE application layer one or more RVQoE reports, with trigger-related indications included with or in the RVQoE report(s) in accordance with the earlier-provided configuration or derived information. The UE AS then forwards the RVQoE reports and trigger-related indications to the RAN node.

In some embodiments, the UE AS retroactively requests the UE application layer to report/indicate if a RVQoE report previously received by the UE AS was triggered and/or the trigger(s) for sending the previous RVQoE report. When the UE AS does this, it may or may not have forwarded the previous RVQoE report to a RAN node. In the case where the UE AS has not yet forwarded the previous RVQoE report to a RAN node, the UE as may subsequently forward the previous RVQoE report to a RAN node, with the trigger-related indications from the UE application layer together with (outside) or included in the previous RVQoE report.

In some embodiments, the UE AS may send indications to a network node that the UE AS and/or the UE application layer supports sending trigger-related indications together with (outside) or included in RVQoE reports. The support for trigger-related indications can be indicated as a UE capability.

In some embodiments the UE application layer receives from the UE AS one or more instructions and/or commands (e.g., AT commands) requesting the UE application layer to send RVQoE report(s) and trigger-related indication(s) together with or included in the RVQoE report(s). In some variants, the UE application layer also receives from the UE AS a configuration of one or more triggers for RVQoE reporting. As an implementation example, the configuration and/or the request can be received from the UE AS via AT command. Upon detecting occurrence of any of the configured triggers, the UE application layer sends the UE AS one or more RVQoE reports, with the trigger-related indication(s) included in or with each RVQoE report. The UE AS can then forward the RVQoE reports and trigger-related information to the RAN node, in the manner described above.

Example implementations of embodiments described above include additions to XnAP defined 3GPP TS 38.423 (v16.8.0) indicating trigger events for transferring RVQoE reporting from one NG-RAN node to another NG-RAN node, e.g., as part of Xn Handover Preparation or Xn Retrieve UE Context procedures. The following table provides a non-exclusive definition for an exemplary “Conditions for RVQoE Handover” IE that can be included in 3GPP TS 38.423.

| | | | | |
|---|---|---|---|---|
| IE/Group Name | Pres. | Range | IE type/ref. | Semantics description |

| | | | |
|---|---|---|---|
| Conditions for | O | BITSTRING | Each bit in the bitmap indicates a condition |
| RVQoE transfer | | (SIZE(32)) | (trigger) causing the transfer of RAN |
| | | | visible QoE reporting. |
| | | | Bit 0 = video stalling during handover. |
| | | | Bit 1 = Cumulative duration of video |
| | | | stalling is above a threshold. |
| | | | Value ‘1’ indicates “condition is verified” |
| | | | and value ‘0’ indicates “condition is not |
| | | | verified”. |
| | | | Unused bits are reserved for future use. |

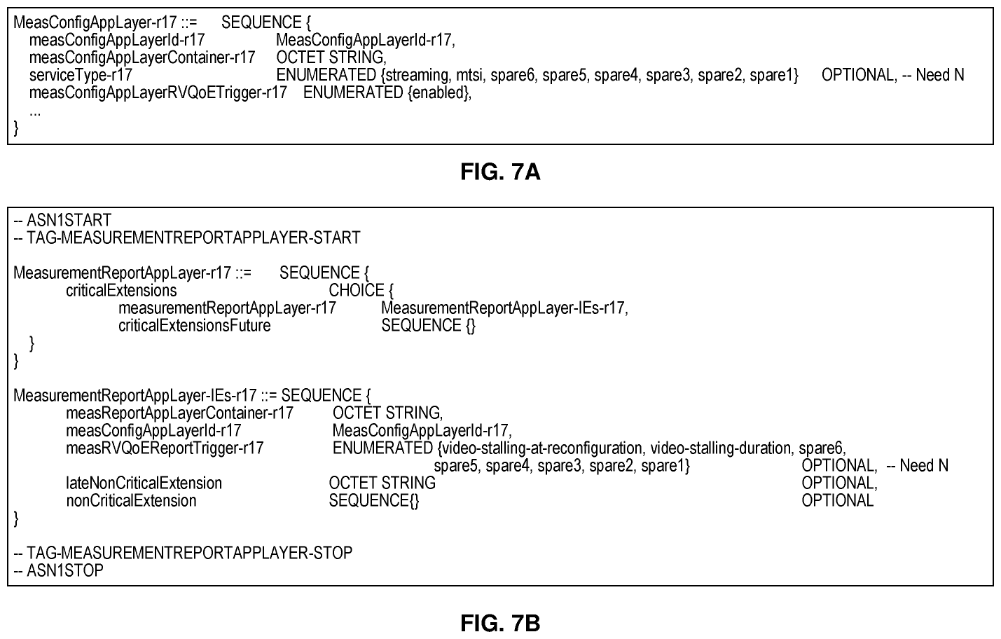

Other example implementations of embodiments described above include additions to RRC protocol defined in 3GPP TS 38.331 (v16.7.0) for indicating trigger events to be verified at UE AS and to be included in RV QoE reporting. FIG. 7A shows an exemplary ASN.1 data structure for a MeasConfigAppLayer-r17 IE that includes a new measConfigAppLayerRVQoETrigger-r17 field, with value “enabled” indicating that trigger reporting is enabled. FIG. 7B shows an exemplary ASN.1 data structures for a MeasurementReportAppLayer-r17 IE and a MeasurementReportAppLayer-IEs-r17 included therein. The latter includes a new measRVQoEReportTrigger-r17 field that has enumerated values identifying or indicating different reporting triggers.

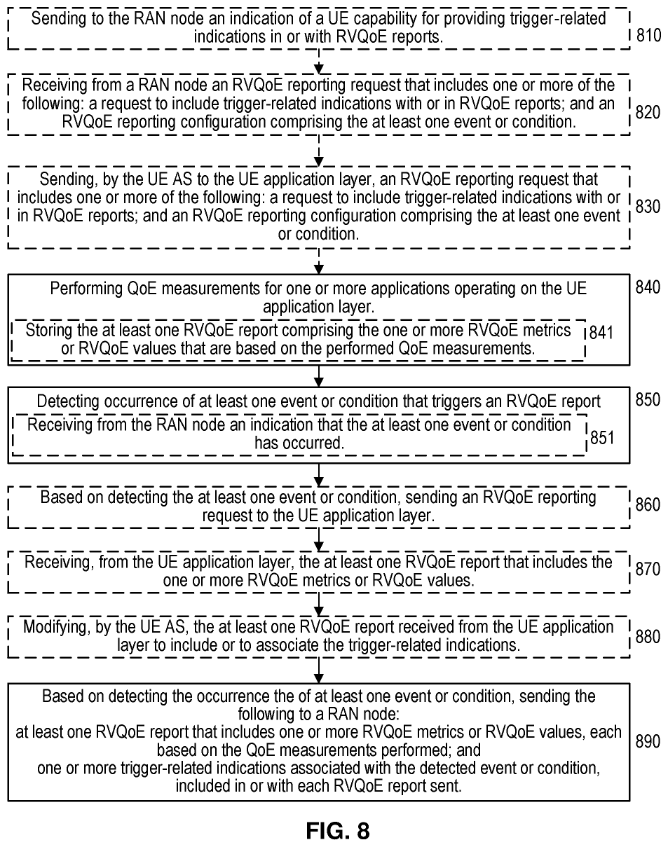

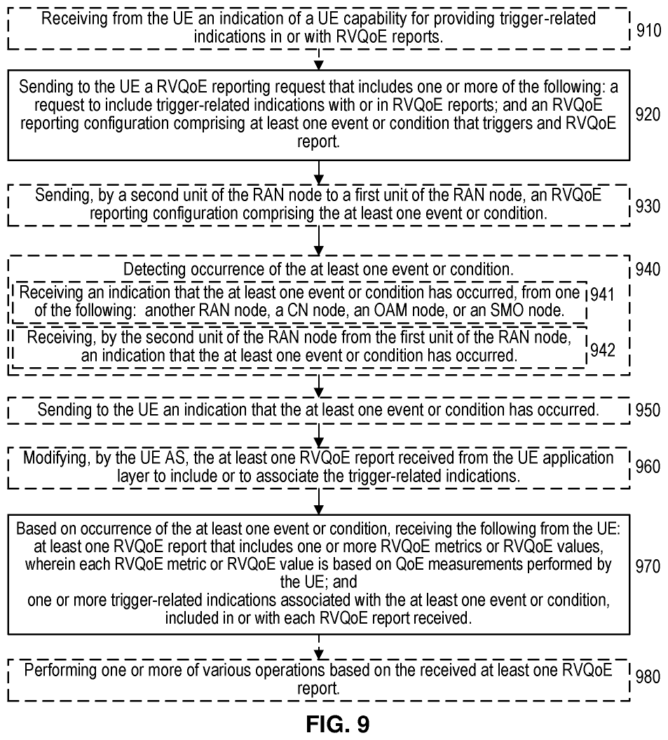

Various features of the embodiments described above correspond to various operations illustrated in FIGS. 8-9, which show exemplary methods (e.g., procedures) for a RAN node and a UE, respectively. In other words, various features of the operations described below correspond to various embodiments described above. Furthermore, the exemplary methods shown in FIGS. 8-9 can be used cooperatively to provide various benefits, advantages, and/or solutions to problems described herein. Although FIGS. 8-9 show specific blocks in particular orders, the operations of the exemplary methods can be performed in different orders than shown and can be combined and/or divided into blocks having different functionality than shown. Optional blocks or operations are indicated by dashed lines.

In particular, FIG. 8 shows an exemplary method (e.g., procedure) for a UE configured to perform QoE measurements in a RAN, according to various embodiments of the present disclosure. The exemplary method can be performed by a UE (e.g., wireless device, etc.) such as described elsewhere herein.

The exemplary method can include the operations of block 840, where the UE can perform QoE measurements for one or more applications operating on the UE application layer. The exemplary method can also include the operations of block 850, where the UE can detect occurrence of at least one event or condition that triggers a RAN-visible QoE (RVQoE) report. The exemplary method can also include the operations of block 890, where based on detecting the occurrence of the at least one event or condition, the UE can send the following to a RAN node:
at least one RVQoE report that includes one or more RVQoE metrics or RVQoE values, wherein each RVQoE metric or RVQoE value is based on QoE measurements performed by the UE; and
one or more trigger-related indications associated with the detected event or condition, included in or with each RVQoE report sent.

In some embodiments, the one or more trigger-related indications include any of the following:
indication that an RVQoE reporting trigger occurred;
indication or identifier of the RVQoE reporting trigger;
a time at which the RVQoE reporting trigger occurred;
cause or reason for occurrence of the RVQoE reporting trigger;
indication or identifier of entity that detected the RVQoE reporting trigger;
type of RVQoE reporting trigger; and
extended information associated with the RVQoE reporting trigger.

In some embodiments, the extended information includes one or more of the following: cell identifier, network slice identifier, network slice type, radio access technology (RAT) identifier, public land mobile network (PLMN) identifier, protocol data unit (PDU) session-related parameters, and respective values of one or more QoE-related parameters that caused the RVQoE reporting trigger. More specific examples of each of these trigger-related indications were discussed above.

In some embodiments, the at least one event or condition is related to one or more of the following:
an RVQoE reporting request from the RAN node;
a duration since last RVQoE report;
an RVQoE reporting configuration from the RAN node;
messages or control elements (CEs) sent to or received from the RAN node;
messages sent between different units of the RAN node;
one or more RAN-related events;
a UE procedure related to mobility, multi-connectivity, and/or state change;
a protocol data unit (PDU) session;
a network slice;
layer-2 and/or radio-related measurements performed by the UE;
one or more RVQoE metrics and/or RVQoE values in relation to corresponding thresholds;
service types, service subtypes, and/or subservice types of the one or more applications being measured; and
session-related events for the one or more applications being measured.
   More specific examples of each of these types of events or conditions were discussed above.

In some embodiments, the exemplary method can also include the operations of block 820, where the UE can receive from the RAN node an RVQoE reporting request that includes one or more of the following: a request to include trigger-related indications with or in RVQoE reports; and an RVQoE reporting configuration comprising the at least one event or condition. In some of these embodiments, the exemplary method can also include the operations of block 810, where the UE can send to the RAN node an indication of a UE capability for providing trigger-related indications in or with RVQoEreports. In such case, the request to include trigger-related indications is received (e.g., in block 820) responsive to the indication of the UE capability.

In some embodiments, the occurrence of the at least one event or condition is detected by a UE access stratum (AS) or by the UE application layer. In some of these embodiments, performing the QoE measurements in block 840 include the operations of sub-block 841, where the UE (e.g., AS or application layer) can store the at least one RVQoE report comprising the one or more RVQoE metrics or RVQoE values that are based on the performed QoE measurements. The at least one event or condition is detected after storing the at least one RVQoE report.

In other embodiments, the exemplary method also includes the operations of blocks 860-870, where based on detecting the at least one event or condition, the UE AS sends an RVQoE reporting request to the UE application layer and receive, from the UE application layer, the at least one RVQoE report that includes the one or more RVQoE metrics or RVQoE values. In some variants, the RVQoE reporting request sent to the UE application layer and the at least one RVQoE report received from the UE application layer include the trigger-related indications. In other variants, the exemplary method can also include the operations of block 880, where the UE AS can modify the at least one RVQoE report received from the UE application layer to include or to associate the trigger-related indications before sending to the RAN node, i.e., before sending to the RAN node in block 890.

In other embodiments, the occurrence of the at least one event or condition is detected by the UE application layer and the exemplary method also includes the operations of block 830, where the UE AS can send to the UE application layer an RVQoE reporting request that includes one or more of the following: a request to include trigger-related indications with or in RVQoE reports; and an RVQoE reporting configuration comprising the at least one event or condition.

In some embodiments, detecting the occurrence of the at least one event or condition in block 850 includes the operations of block 851, where the UE (e.g., AS or application layer) receives from the RAN node an indication that the at least one event or condition has occurred.

In addition, FIG. 9 shows an exemplary method (e.g., procedure) for a RAN node configured to manage QoE measurements by UEs in the RAN, according to various embodiments of the present disclosure. The exemplary method can be performed by a RAN node (e.g., base station, eNB, gNB, ng-eNB, TRP, etc.) such as described elsewhere herein.

The exemplary method can include the operations of block 920, where the RAN node can send to a UE an RVQoE reporting request that includes one or more of the following: a request to include trigger-related indications with or in RVQoE reports, and a reporting configuration comprising at least one event or condition that triggers an RVQoE report. The exemplary method can also include the operations of block 970, where based on occurrence of the at least one event or condition, the RAN node can receive the following from the UE:
at least one RVQoE report that includes one or more RVQoE metrics or RVQoE values, wherein each RVQoE metric or RVQoE value is based on QoE measurements performed by the UE; and
one or more trigger-related indications associated with the at least one event or condition, included in or with each RVQoE report received.

In various embodiments, the one or more trigger-related indications can include any of those described above in relation to UE embodiments. In various embodiments, the at least one event or condition can include any of the events or conditions described above in relation to UE embodiments.

In some embodiments, the exemplary method can also include the operations of block 910, where the RAN node can receive from the UE an indication of a UE capability for providing trigger-related indications in or with RVQoEreports. The request to include trigger-related indications is included in the RVQoE reporting request (e.g., sent in block 920) responsive to the indication of the UE capability.

In some embodiments, the at least one event or condition is detected by a UE application layer or by a UE AS (i.e., of the UE that provided the RVQoE report(s)). Some examples were described above in relation to UE embodiments.

In other embodiments, the exemplary method can also include the operations of blocks 940-950, where the RAN node can detect the occurrence of the at least one event or condition and send to the UE an indication that the at least one event or condition has occurred. In such case, the at least one RVQoE report is received (e.g., in block 970) in response to sending the indication.

In some of these embodiments, the occurrence of the at least one event or condition is detected by a first unit of the RAN node and the indication is sent to the UE by a second unit of the RAN node. In addition, detecting the occurrence of the at least one event or condition in block 940 includes the operations of block 942, where the second unit can receive, from the first unit, the indication that the at least one event or condition has occurred (i.e., which the second unit sends to the UE). In some variants, the exemplary method can also include the operations of block 930, where the second unit sends, to the first unit, an RVQoE reporting configuration comprising the at least one event or condition (i.e., upon which the first unit bases the detection).

In different variants of these embodiments, the second unit of the RAN node is a CU-CP and one of following applies:
the first unit of the RAN node is a DU and the indication sent by the first unit is an F1AP message; or
the first unit is a CU-UP and the indication sent by the first unit is an E1AP message.

In other of these embodiments, detecting the occurrence of the at least one event or condition in block 940 includes the operations of block 941, where the RAN node can receive an indication that the at least one event or condition has occurred, from one of the following: another RAN node, a core network (CN) node, an operations administration and maintenance (OAM) node, or a service management and orchestration (SMO) node.

In some embodiments, the exemplary method can also include the operations of block 980, where the RAN node can perform one or more of the following based on the received at least one RVQoE report:
managing carrier aggregation (CA) and/or dual connectivity (DC) for the UE;
scheduling and/or link adaptation for data associated with a UE application;
selecting a type of handover or other mobility operation to be performed by the UE;
evaluating a handover or other mobility operation previously performed by the UE; and
training one or more artificial intelligence/machine learning (AI/ML) models.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

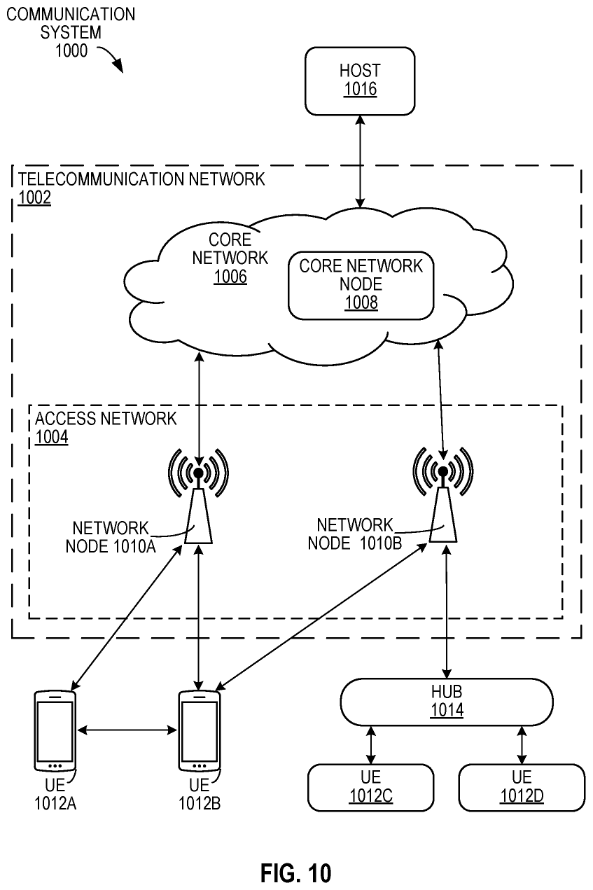

FIG. 10 shows an example of a communication system 1000 in accordance with some embodiments. In this example, communication system 1000 includes telecommunication network 1002 that includes an access network 1004 (e.g., RAN) and a core network 1006, which includes one or more core network nodes 1008. Access network 1004 includes one or more access network nodes, such as network nodes 1010a-b (one or more of which may be generally referred to as network nodes 1010), or any other similar 3GPP access node or non-3GPP access point. Network nodes 1010 facilitate direct or indirect connection of UEs, such as by connecting UEs 1012a-d (one or more of which may be generally referred to as UEs 1012) to core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1000 may include any number of wired or wireless networks, network nodes, UEs, and/or any other components or systems that may facilitate or participate in the communication of data and/or signals whether via wired or wireless connections. Communication system 1000 may include and/or interface with any type of communication, telecommunication, data, cellular, radio network, and/or other similar type of system.

UEs 1012 may be any of a wide variety of communication devices, including wireless devices arranged, configured, and/or operable to communicate wirelessly with network nodes 1010 and other communication devices. Similarly, network nodes 1010 are arranged, capable, configured, and/or operable to communicate directly or indirectly with UEs 1012 and/or with other network nodes or equipment in telecommunication network 1002 to enable and/or provide network access, such as wireless network access, and/or to perform other functions, such as administration in telecommunication network 1002.

In the depicted example, core network 1006 connects network nodes 1010 to one or more hosts, such as host 1016. These connections may be direct or indirect via one or more intermediary networks or devices. In other examples, network nodes may be directly coupled to hosts. Core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1016 may be under the ownership or control of a service provider other than an operator or provider of access network 1004 and/or telecommunication network 1002, and may be operated by the service provider or on behalf of the service provider. Host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); LTE, and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1002 is a cellular network that implements 3GPP standardized features. Accordingly, telecommunication network 1002 may support network slicing to provide different logical networks to different devices that are connected to telecommunication network 1002. For example, telecommunication network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1012 are configured to transmit and/or receive information without direct human interaction. For instance, a UE may be designed to transmit information to access network 1004 on a predetermined schedule, when triggered by an internal or external event, or in response to requests from access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1014 communicates with access network 1004 to facilitate indirect communication between one or more UEs (e.g., UE 1012c and/or 1012d) and network nodes (e.g., network node 1010b). In some examples, hub 1014 may be a controller, router, content source and analytics, or any of the other communication devices described herein regarding UEs. For example, hub 1014 may be a broadband router enabling access to core network 1006 for the UEs. As another example, hub 1014 may be a controller that sends commands or instructions to one or more actuators in the UEs. Commands or instructions may be received from the UEs, network nodes 1010, or by executable code, script, process, or other instructions in hub 1014. As another example, hub 1014 may be a data collector that acts as temporary storage for UE data and, in some embodiments, may perform analysis or other processing of the data. As another example, hub 1014 may be a content source. For example, for a UE that is a VR headset, display, loudspeaker or other media delivery device, hub 1014 may retrieve VR assets, video, audio, or other media or data related to sensory information via a network node, which hub 1014 then provides to the UE either directly, after performing local processing, and/or after adding additional local content. In still another example, hub 1014 acts as a proxy server or orchestrator for the UEs, in particular in if one or more of the UEs are low energy IoT devices.

Hub 1014 may have a constant/persistent or intermittent connection to the network node 1010b. Hub 1014 may also allow for a different communication scheme and/or schedule between hub 1014 and UEs (e.g., UE 1012c and/or 1012d), and between hub 1014 and core network 1006. In other examples, hub 1014 is connected to core network 1006 and/or one or more UEs via a wired connection. Moreover, hub 1014 may be configured to connect to an M2M service provider over access network 1004 and/or to another UE over a direct connection. In some scenarios, UEs may establish a wireless connection with network nodes 1010 while still connected via hub 1014 via a wired or wireless connection. In some embodiments, hub 1014 may be a dedicated hub—that is, a hub whose primary function is to route communications to/from the UEs from/to network node 1010b. In other embodiments, hub 1014 may be a non-dedicated hub—that is, a device which is capable of operating to route communications between the UEs and network node 1010b, but which is additionally capable of operating as a communication start and/or end point for certain data channels.

FIG. 11 shows a UE 1100 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

Processing circuitry 1102 is configured to process instructions and data and may be configured to implement any sequential state machine operative to execute instructions stored as machine-readable computer programs in memory 1110. Processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1102 may include multiple central processing units (CPUs).

In the example, input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1108 is structured as a battery or battery pack. Other types of power sources, such as an external power source (e.g., an electricity outlet), photovoltaic device, or power cell, may be used. Power source 1108 may further include power circuitry for delivering power from power source 1108 itself, and/or an external power source, to the various parts of UE 1100 via input circuitry or an interface such as an electrical power cable. Delivering power may be, for example, for charging of power source 1108. Power circuitry may perform any formatting, converting, or other modification to the power from power source 1108 to make the power suitable for the respective components of UE 1100 to which power is supplied.

Memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1110 includes one or more application programs 1114, such as an operating system, web browser application, a widget, gadget engine, or other application, and corresponding data 1116. Memory 1110 may store, for use by UE 1100, any of a variety of various operating systems or combinations of operating systems.

Memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1110 may allow UE 1100 to access instructions, application programs and the like, stored on transitory or non-transitory memory media, to off-load data, or to upload data. An article of manufacture, such as one utilizing a communication system may be tangibly embodied as or in memory 1110, which may be or comprise a device-readable storage medium.

Processing circuitry 1102 may be configured to communicate with an access network or other network using communication interface 1112. Communication interface 1112 may comprise one or more communication subsystems and may include or be communicatively coupled to an antenna 1122. Communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, transmitter 1118 and receiver 1120 may be coupled to one or more antennas (e.g., antenna 1122) and may share circuit components, software or firmware, or alternatively be implemented separately.

In the illustrated embodiment, communication functions of communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1100 shown in FIG. 11.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

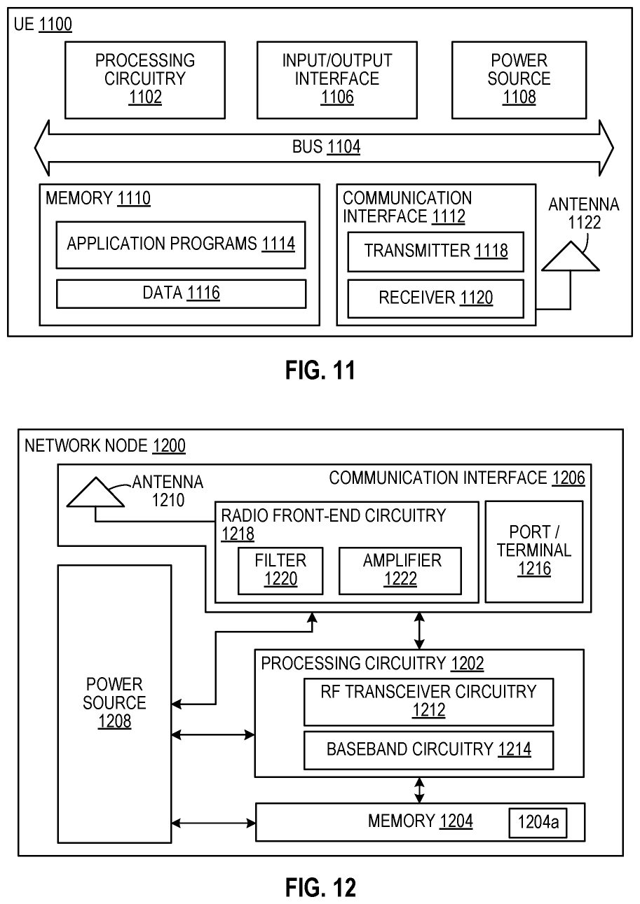

FIG. 12 shows a network node 1200 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1200 includes a processing circuitry 1202, a memory 1204, a communication interface 1206, and a power source 1208. Network node 1200 may be composed of multiple physically separate components (e.g., a NodeB component and a RNC component, or a BTS component and a BSC component, etc.), which may each have their own respective components. In certain scenarios in which network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). Network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

Processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as memory 1204, to provide network node 1200 functionality.

In some embodiments, processing circuitry 1202 includes a system on a chip (SOC). In some embodiments, processing circuitry 1202 includes one or more of radio frequency (RF) transceiver circuitry 1212 and baseband processing circuitry 1214. In some embodiments, RF transceiver circuitry 1212 and baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

Memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1202. Memory 1204 may store any suitable instructions, data, or information, including a computer program, software, an application including one or more of logic, rules, code, tables, and/or other instructions (collectively denoted computer program product 1204a) capable of being executed by processing circuitry 1202 and utilized by network node 1200. Memory 1204 may be used to store any calculations made by processing circuitry 1202 and/or any data received via communication interface 1206. In some embodiments, processing circuitry 1202 and memory 1204 is integrated.

Communication interface 1206 is used in wired or wireless communication of signaling and/or data between a network node, access network, and/or UE. As illustrated, communication interface 1206 comprises port(s)/terminal(s) 1216 to send and receive data, for example to and from a network over a wired connection. Communication interface 1206 also includes radio front-end circuitry 1218 that may be coupled to, or in certain embodiments a part of, antenna 1210. Radio front-end circuitry 1218 comprises filters 1220 and amplifiers 1222. Radio front-end circuitry 1218 may be connected to an antenna 1210 and processing circuitry 1202. The radio front-end circuitry may be configured to condition signals communicated between antenna 1210 and processing circuitry 1202. Radio front-end circuitry 1218 may receive digital data that is to be sent out to other network nodes or UEs via a wireless connection. Radio front-end circuitry 1218 may convert the digital data into a radio signal having the appropriate channel and bandwidth parameters using a combination of filters 1220 and/or amplifiers 1222. The radio signal may then be transmitted via antenna 1210. Similarly, when receiving data, antenna 1210 may collect radio signals which are then converted into digital data by radio front-end circuitry 1218. The digital data may be passed to processing circuitry 1202. In other embodiments, the communication interface may comprise different components and/or different combinations of components.

In certain alternative embodiments, network node 1200 does not include separate radio front-end circuitry 1218, instead, processing circuitry 1202 includes radio front-end circuitry and is connected to antenna 1210. Similarly, in some embodiments, all or some of RF transceiver circuitry 1212 is part of communication interface 1206. In still other embodiments, communication interface 1206 includes one or more ports or terminals 1216, radio front-end circuitry 1218, and RF transceiver circuitry 1212, as part of a radio unit (not shown), and communication interface 1206 communicates with baseband processing circuitry 1214, which is part of a digital unit (not shown).

Antenna 1210 may include one or more antennas, or antenna arrays, configured to send and/or receive wireless signals. Antenna 1210 may be coupled to radio front-end circuitry 1218 and may be any type of antenna capable of transmitting and receiving data and/or signals wirelessly. In certain embodiments, antenna 1210 is separate from network node 1200 and connectable to network node 1200 through an interface or port.

Antenna 1210, communication interface 1206, and/or processing circuitry 1202 may be configured to perform any receiving operations and/or certain obtaining operations described herein as being performed by the network node. Any information, data and/or signals may be received from a UE, another network node and/or any other network equipment. Similarly, antenna 1210, communication interface 1206, and/or processing circuitry 1202 may be configured to perform any transmitting operations described herein as being performed by the network node. Any information, data and/or signals may be transmitted to a UE, another network node and/or any other network equipment.

Power source 1208 provides power to the various components of network node 1200 in a form suitable for the respective components (e.g., at a voltage and current level needed for each respective component). Power source 1208 may further comprise, or be coupled to, power management circuitry to supply the components of network node 1200 with power for performing the functionality described herein. For example, network node 1200 may be connectable to an external power source (e.g., the power grid, an electricity outlet) via an input circuitry or interface such as an electrical cable, whereby the external power source supplies power to power circuitry of power source 1208. As a further example, power source 1208 may comprise a source of power in the form of a battery or battery pack which is connected to, or integrated in, power circuitry. The battery may provide backup power should the external power source fail.

Embodiments of network node 1200 may include additional components beyond those shown in FIG. 12 for providing certain aspects of the network node's functionality, including any of the functionality described herein and/or any functionality necessary to support the subject matter described herein. For example, network node 1200 may include user interface equipment to allow input of information into network node 1200 and to allow output of information from network node 1200. This may allow a user to perform diagnostic, maintenance, repair, and other administrative functions for network node 1200.

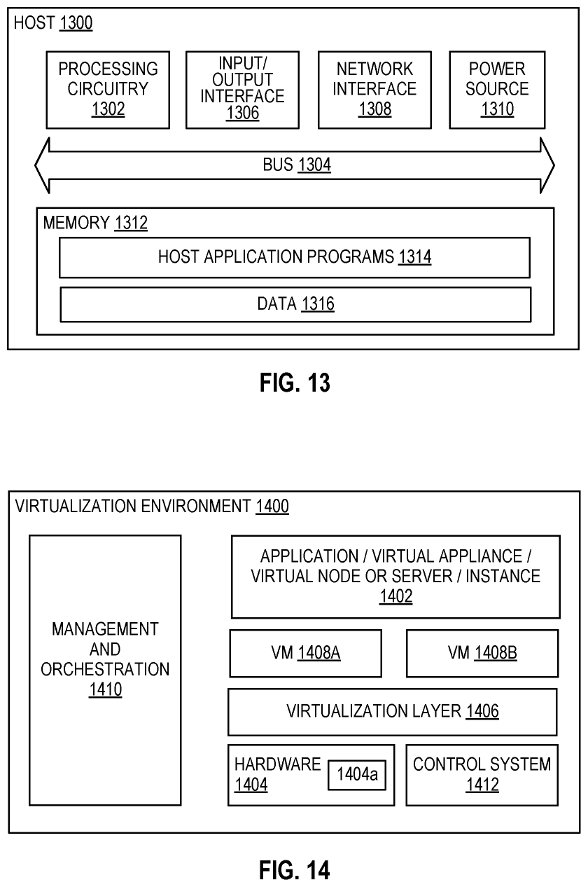

FIG. 13 is a block diagram of a host 1300, which may be an embodiment of host 1016 of FIG. 10, in accordance with various embodiments. In general, host 1300 may be or comprise various combinations hardware and/or software, including a standalone server, a blade server, a cloud-implemented server, a distributed server, a virtual machine, container, or processing resources in a server farm. Host 1300 may provide services to one or more UEs.

Host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

Memory 1312 may include one or more computer programs including one or more host application programs 1314 and data 1316, which may include user data, e.g., data generated by a UE for host 1300 or data generated by host 1300 for a UE. Embodiments of host 1300 may utilize only a subset or all of the components shown. Host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1314 may also provide for user authentication and licensing checks and may periodically report health, routes, and content availability to a central node, such as a device in or on the edge of a core network. Accordingly, host 1300 may select and/or indicate a different host for over-the-top services for a UE. Host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in virtualization environment 1400 to implement some of the features, functions, and/or benefits of some of the embodiments disclosed herein.

Hardware 1404 includes processing circuitry, memory that stores software and/or instructions (collectively denoted computer program product 1404a) executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a-b (one or more of which may be generally referred to as VMs 1408), and/or perform any of the functions, features and/or benefits described in relation with some embodiments described herein. Virtualization layer 1406 may present a virtual operating platform that appears like networking hardware to VMs 1408.

VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

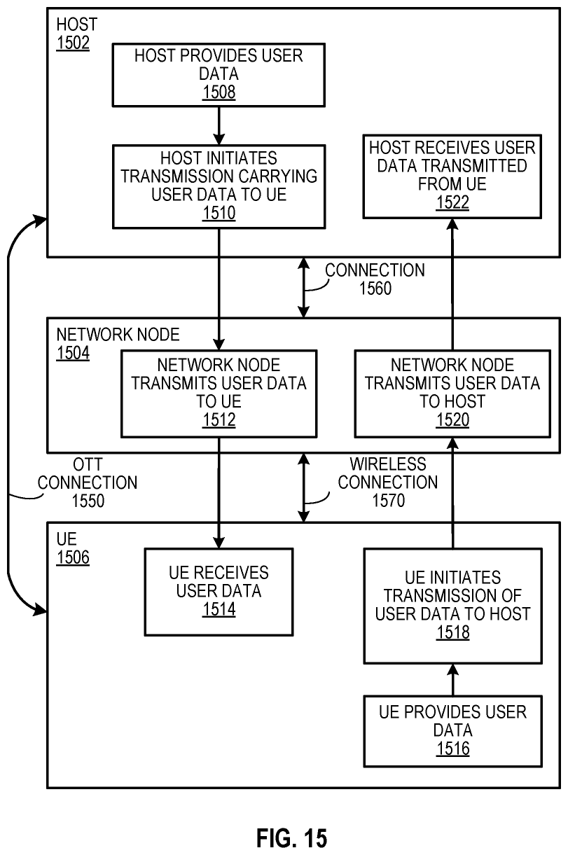

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. Host 1502 also includes software, which is stored in or accessible by host 1502 and executable by the processing circuitry. The software includes a host application that may be operable to provide a service to a remote user, such as UE 1506 connecting via an over-the-top (OTT) connection 1550 extending between UE 1506 and host 1502. In providing the service to the remote user, a host application may provide user data which is transmitted using OTT connection 1550.

Network node 1504 includes hardware enabling it to communicate with host 1502 and UE 1506. Connection 1560 may be direct or pass through a core network (like core network 1006 of FIG. 10) and/or one or more other intermediate networks, such as one or more public, private, or hosted networks. For example, an intermediate network may be a backbone network or the Internet.

UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of host 1502. In host 1502, an executing host application may communicate with the executing client application via OTT connection 1550 terminating at UE 1506 and host 1502. In providing the service to the user, the UE's client application may receive request data from the host's host application and provide user data in response to the request data. OTT connection 1550 may transfer both the request data and the user data. The UE's client application may interact with the user to generate the user data that it provides to the host application through OTT connection 1550.

OTT connection 1550 may extend via a connection 1560 between host 1502 and network node 1504 and via a wireless connection 1570 between network node 1504 and UE 1506 to provide the connection between host 1502 and UE 1506. Connection 1560 and wireless connection 1570, over which OTT connection 1550 may be provided, have been drawn abstractly to illustrate the communication between host 1502 and UE 1506 via network node 1504, without explicit reference to any intermediary devices and the precise routing of messages via these devices.

As an example of transmitting data via OTT connection 1550, in step 1508, host 1502 provides user data, which may be performed by executing a host application. In some embodiments, the user data is associated with a particular human user interacting with UE 1506. In other embodiments, the user data is associated with a UE 1506 that shares data with host 1502 without explicit human interaction. In step 1510, host 1502 initiates a transmission carrying the user data towards UE 1506. Host 1502 may initiate the transmission responsive to a request transmitted by UE 1506. The request may be caused by human interaction with UE 1506 or by operation of the client application executing on UE 1506. The transmission may pass via network node 1504, in accordance with the teachings of the embodiments described throughout this disclosure. Accordingly, in step 1512, network node 1504 transmits to UE 1506 the user data that was carried in the transmission that host 1502 initiated, in accordance with the teachings of the embodiments described throughout this disclosure. In step 1514, UE 1506 receives the user data carried in the transmission, which may be performed by a client application executed on UE 1506 associated with the host application executed by host 1502.

In some examples, UE 1506 executes a client application which provides user data to host 1502. The user data may be provided in reaction or response to the data received from host 1502. Accordingly, in step 1516, UE 1506 may provide user data, which may be performed by executing the client application. In providing the user data, the client application may further consider user input received from the user via an input/output interface of UE 1506. Regardless of the specific manner in which the user data was provided, UE 1506 initiates, in step 1518, transmission of the user data towards host 1502 via network node 1504. In step 1520, in accordance with the teachings of the embodiments described throughout this disclosure, network node 1504 receives user data from UE 1506 and initiates transmission of the received user data towards host 1502. In step 1522, host 1502 receives the user data carried in the transmission initiated by UE 1506.

One or more of the various embodiments improve the performance of OTT services provided to UE 1506 using OTT connection 1550, in which wireless connection 1570 forms the last segment. More precisely, embodiments can facilitate a RAN node to receive UE application-related information that it can understand and use for radio network optimization tasks. Examples of RAN use cases that can benefit from such application-related information include QoE-aware traffic steering, scheduling and link adaptation, mobility-related decisions, mobility decision evaluation, and inputs to AI/ML algorithms used for network optimization and/or fault prediction. By improving RAN performance by the reporting of RAN-visible QoE measurements in this manner, embodiments facilitate improved RAN performance as experienced by applications, including OTT services. These improvements increase the value of such OTT services to end users and service providers.

In an example scenario, factory status information may be collected and analyzed by host 1502. As another example, host 1502 may process audio and video data which may have been retrieved from a UE for use in creating maps. As another example, host 1502 may collect and analyze real-time data to assist in controlling vehicle congestion (e.g., controlling traffic lights). As another example, host 1502 may store surveillance video uploaded by a UE. As another example, host 1502 may store or control access to media content such as video, audio, VR or AR which it can broadcast, multicast or unicast to UEs. As other examples, host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1550 between host 1502 and UE 1506, in response to variations in the measurement results. The measurement procedure and/or the network functionality for reconfiguring the OTT connection may be implemented in software and hardware of host 1502 and/or UE 1506. In some embodiments, sensors (not shown) may be deployed in or in association with other devices through which OTT connection 1550 passes; the sensors may participate in the measurement procedure by supplying values of the monitored quantities exemplified above or by supplying values of other physical quantities from which software may compute or estimate the monitored quantities. The reconfiguring of OTT connection 1550 may include message format, retransmission settings, preferred routing etc.; the reconfiguring need not directly alter the operation of network node 1504. Such procedures and functionalities may be known and practiced in the art. In certain embodiments, measurements may involve proprietary UE signaling that facilitates measurements of throughput, propagation times, latency and the like, by host 1502. The measurements may be implemented in that software causes messages to be transmitted, in particular empty or ‘dummy’ messages, using OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method for a user equipment (UE) configured to perform quality-of-experience (QoE) measurements in a radio access network (RAN), the method comprising:
performing QoE measurements for one or more applications operating on the UE application layer;
detecting the occurrence of at least one event or condition that triggers a RAN-visible QoE (RVQoE) report; and
based on detecting the occurrence of the at least one event or condition, sending to a RAN node at least one RVQoE report that includes the following:
   one or more RVQoE metrics or RVQoE values, each based on the QoE measurements performed; and
   one or more trigger-related indications associated with the detected event or condition.

A2. The method of embodiment A1, wherein the one or more trigger-related indications include any of the following:
indication that an RVQoE reporting trigger occurred;
indication or identifier of the RVQoE reporting trigger;
a time at which the RVQoE reporting trigger occurred;
cause or reason for occurrence of the RVQoE reporting trigger;
indication or identifier of entity that detected the RVQoE reporting trigger; type of RVQoE reporting trigger; and
extended information associated with the RVQoE reporting trigger.

A3. The method of embodiment A2, wherein the extended information includes one or more of the following: cell identifier, network slice identifier, network slice type, radio access technology (RAT) identifier, public land mobile network (PLMN) identifier, protocol data unit (PDU) session-related parameters, and value of a QoE-related parameter that caused the RVQoE reporting trigger.

A4. The method of any of embodiments A1-A3, wherein the at least one event or condition is related to one or more of the following:
an RVQoE reporting request from the RAN node;
a duration since last RVQoE report;
an RVQoE reporting configuration from the RAN node;
messages or control elements (CEs) sent to or received from the RAN node;
messages sent between different units of the RAN node;
one or more RAN-related events;
a UE procedure related to mobility, multi-connectivity, and/or state change;
a protocol data unit (PDU) session;
a network slice;
layer-2 and/or radio-related measurements performed by the UE;
one or more RVQoE metrics and/or RVQoE values in relation to corresponding thresholds;
service types, service subtypes, and/or subservice types of the one or more applications being measured; and
session-related events for the one or more applications being measured.

A5. The method of any of embodiments A1-A4, further comprising receiving from the RAN node an RVQoE reporting request that includes one or more of the following:
a request to include trigger-related indications with or in RVQoE reports; and
an RVQoE reporting configuration comprising the at least one event or condition.

A6. The method of embodiment A5, further comprising sending to the RAN node an indication of a UE capability for providing trigger-related indications with RVQoE reports, wherein the request to include trigger-related indications is received responsive to the indication of the UE capability.

A7. The method of any of embodiments A1-A6, wherein the occurrence of the at least one event or condition is detected by the UE access stratum (AS).

A8. The method of embodiment A7, wherein performing the QoE measurements comprises storing the at least one RVQoE report comprising the one or more RVQoE metrics or RVQoE values that are based on the performed QoE measurements, wherein the at least one event or condition is detected after storing the at least one RVQoE report.

A9. The method of embodiment A7, further comprises, by the UE AS:
based on detecting the at least one event or condition, sending an RVQoE reporting request to the UE application layer; and
receiving, from the UE application layer, the at least one RVQoE report that includes the one or more RVQoE metrics or RVQoE values.

A10. The method of embodiment A9, wherein one of the following applies:
the RVQoE reporting request sent to the UE application layer and the at least one RVQoE report received from the UE application layer include the trigger-related indications; or
the method further comprises modifying, by the UE AS, the at least one RVQoE report received from the UE application layer to include or to associate the trigger-related indications before sending to the RAN node.

A11. The method of any of embodiments A1-A6, wherein:
the occurrence of the at least one event or condition is detected by the UE application layer; and
the method further comprises sending, by the UE AS to the UE application layer, an RVQoE reporting request that includes one or more of the following:
   a request to include trigger-related indications with or in RVQoE reports; and
   an RVQoE reporting configuration comprising the at least one event or condition.

A12. The method of any of embodiments A1-A11, wherein detecting the occurrence of the at least one event or condition comprises receiving from the RAN node an indication that the at least one event or condition has occurred.

B1. A method for a radio access network (RAN) node configured to manage quality-of-experience (QoE) measurements by user equipment (UEs) in the RAN, the method comprising:
sending, to a UE, an RAN-visible QoE (RVQoE) reporting request that includes one or more of the following:
   a request to include trigger-related indications with or in RVQoE reports, and
   a reporting configuration comprising at least one event or condition that triggers an RVQoE report;
based on occurrence of the at least one event or condition, receiving from the UE at least one RVQoE report that includes the following:
   one or more RVQoE metrics or RVQoE values, each based on QoE measurements performed by the UE; and
   one or more trigger-related indications associated with the at least one event or condition.

B2. The method of embodiment B1, wherein the one or more trigger-related indications include any of the following:
indication that an RVQoE reporting trigger occurred;
indication or identifier of the RVQoE reporting trigger;
a time at which the RVQoE reporting trigger occurred;
cause or reason for occurrence of the RVQoE reporting trigger;
indication or identifier of entity that detected the RVQoE reporting trigger; type of RVQoE reporting trigger; and
extended information associated with the RVQoE reporting trigger.

B3. The method of embodiment B2, wherein the extended information includes one or more of the following: cell identifier, network slice identifier, network slice type, radio access technology (RAT) identifier, public land mobile network (PLMN) identifier, protocol data unit (PDU) session-related parameters, and value of a QoE-related parameter that caused the RVQoE reporting trigger.

B4. The method of any of embodiments B1-B3, wherein the at least one event or condition is related to one or more of the following:
an RVQoE reporting request sent to the UE;
a duration since last RVQoE report;
an RVQoE reporting configuration sent to the UE;
messages or control elements (CEs) sent to or received from the UE;
messages sent between different units of the RAN node;
one or more RAN-related events;
a UE procedure related to mobility, multi-connectivity, and/or state change;
a protocol data unit (PDU) session;
a network slice;
layer-2 and/or radio-related measurements performed by the UE;
one or more RVQoE metrics and/or RVQoE values in relation to corresponding thresholds;
service types, service subtypes, and/or subservice types of the one or more applications being measured; and
session-related events for the one or more applications being measured.

B5. The method of any of embodiments B1-B4, further comprising receiving from the UE an indication of a UE capability for providing trigger-related indications with RVQoE reports, wherein the request to include trigger-related indications is included in the RVQoE reporting request responsive to the indication of the UE capability.

B6. The method of any of embodiments B1-B5, wherein the at least one event or condition is detected by one of the following: the UE application layer, or the UE access stratum (AS).

B7. The method of any of embodiments B1-B5, further comprising:
detecting the occurrence of the at least one event or condition; and
sending to the UE an indication that the at least one event or condition has occurred,
wherein the at least one RVQoE report is received in response to sending the indication.

B8. The method of embodiment B7, wherein:
the occurrence of the at least one event or condition is detected by a first unit of the RAN node;
the indication is sent to the UE by a second unit of the RAN node; and
detecting the occurrence of the at least one event or condition comprises receiving, by the second unit from the first unit, the indication that the at least one event or condition has occurred.

B9. The method of embodiment B8, further comprising sending, by the second unit to the first unit, an RVQoE reporting configuration comprising the at least one event or condition.

B10. The method of any of embodiments B8-B9, wherein the second unit is a centralized unit control plane (CU-CP) and one of the following applies:
the first unit is a distributed unit (DU) and the indication sent by the first unit is an F1AP message; or
the first unit is a centralized unit user plane (CU-UP) and the indication sent by the first unit is an E1AP message.

B11. The method of embodiment B7, wherein detecting the occurrence of the at least one event or condition comprises receiving an indication that the at least one event or condition has occurred from one of the following: another RAN node, a core network (CN) node, an operations administration and maintenance (OAM) node, or a service management and orchestration (SMO) node.

C1. A user equipment (UE) configured to perform quality-of-experience (QoE) measurements in a radio access network (RAN), the UE comprising:
communication interface circuitry configured to communicate with a RAN node; and
processing circuitry operatively coupled to the radio transceiver circuitry, whereby the processing circuitry and the radio transceiver circuitry are configured to perform operations corresponding to any of the methods of embodiments A1-A12.

C2. A user equipment (UE) configured to perform quality-of-experience (QoE) measurements in a radio access network (RAN), the UE being further configured to perform operations corresponding to any of the methods of embodiments A1-A12.

C3. A non-transitory, computer-readable medium storing computer-executable instructions that, when executed by processing circuitry of a user equipment (UE) configured to perform quality-of-experience (QoE) measurements in a radio access network (RAN), configure the UE to perform operations corresponding to any of the methods of embodiments A1-A12.

C4. A computer program product comprising computer-executable instructions that, when executed by processing circuitry of a user equipment (UE) configured to perform quality-of-experience (QoE) measurements in a radio access network (RAN), configure the UE to perform operations corresponding to any of the methods of embodiments A1-A12.

D1. A radio access network (RAN) node configured to manage quality-of-experience (QoE) measurements by user equipment (UEs) in the RAN, the RAN node comprising:
communication interface circuitry configured to communicate with UEs and with one or more other RAN nodes; and
processing circuitry operatively coupled to the communication interface circuitry, whereby the processing circuitry and the communication interface circuitry are configured to perform operations corresponding to any of the methods of embodiments B1-B11.

D2. A radio access network (RAN) node configured to manage quality-of-experience (QoE) measurements by user equipment (UEs) in the RAN, the RAN node being further configured to perform operations corresponding to any of the methods of embodiments B1-B11.

D3. A non-transitory, computer-readable medium storing computer-executable instructions that, when executed by processing circuitry of a radio access network (RAN) node configured to manage quality-of-experience (QoE) measurements by user equipment (UEs) in the RAN, configure the RAN node to perform operations corresponding to any of the methods of embodiments B1-B11.

D4. A computer program product comprising computer-executable instructions that, when executed by processing circuitry of a radio access network (RAN) node configured to manage quality-of-experience (QoE) measurements by user equipment (UEs) in the RAN, configure the RAN node to perform operations corresponding to any of the methods of embodiments B1-B11.

1.-36. (canceled)

37. A method for a user equipment (UE) configured to perform quality-of-experience (QoE) measurements in a radio access network (RAN), the method comprising:
performing QoE measurements for one or more applications operating on a UE application layer;
detecting occurrence of at least one event or condition that triggers a RAN-visible QoE (RVQoE) report; and
based on detecting the occurrence of the at least one event or condition, sending the following to a RAN node:
at least one RVQoE report that includes one or more RVQoE metrics or RVQoE values, wherein each RVQoE metric or RVQoE value is based on the QoE measurements performed; and
one or more trigger-related indications associated with the detected event or condition, included in or with each RVQoE report sent.

38. The method of claim 37, wherein the one or more trigger-related indications include any of the following:
indication that an RVQoE reporting trigger occurred;
indication or identifier of the RVQoE reporting trigger;
a time at which the RVQoE reporting trigger occurred;
cause or reason for occurrence of the RVQoE reporting trigger;
indication or identifier of entity that detected the RVQoE reporting trigger;
type of RVQoE reporting trigger; and
extended information associated with the RVQoE reporting trigger.

39. The method of claim 38, wherein the extended information includes one or more of the following: cell identifier; network slice identifier; network slice type; radio access technology (RAT) identifier; public land mobile network (PLMN) identifier; protocol data unit (PDU) session-related parameters; and respective values of one or more QoE-related parameters that caused the RVQoE reporting trigger.

40. The method of claim 37, wherein the at least one event or condition is related to one or more of the following:
an RVQoE reporting request from the RAN node;
a duration since last RVQoE report;
an RVQoE reporting configuration from the RAN node;
messages or control elements (CEs) sent to or received from the RAN node;
messages sent between different units of the RAN node;
one or more RAN-related events;
a UE procedure related to mobility, multi-connectivity, and/or Radio Resource Control (RRC) state change;
a protocol data unit (PDU) session;
a network slice;
layer-2 and/or radio-related measurements performed by the UE;
one or more RVQoE metrics and/or RVQoE values in relation to corresponding thresholds;
service types, service subtypes, and/or subservice types of the one or more applications being measured; and
session-related events for the one or more applications being measured.

41. The method of claim 37, further comprising receiving from the RAN node an RVQoE reporting request that includes one or more of the following:
a request to include trigger-related indications with or in RVQoE reports; and
an RVQoE reporting configuration comprising the at least one event or condition.

42. The method of claim 37, wherein:
the occurrence of the at least one event or condition is detected by a UE access stratum (AS); and
the method further comprises:
based on detecting occurrence of the at least one event or condition, the UE AS sending an RVQoE reporting request to the UE application layer; and
receiving, by the UE AS from the UE application layer, the at least one RVQoE report that includes the one or more RVQoE metrics or RVQoE values.

43. The method of claim 42, wherein one of the following applies:
the RVQoE reporting request sent to the UE application layer and the at least one RVQoE report received from the UE application layer include the trigger-related indications; or
the method further comprises modifying, by the UE AS, the at least one RVQoE report received from the UE application layer to include or to associate the trigger-related indications, before sending the at least one RVQoE report to the RAN node.

44. The method of claim 37, wherein:
the occurrence of the at least one event or condition is detected by the UE application layer; and
the method further comprises sending, by the UE AS to the UE application layer, an RVQoE reporting request that includes one or more of the following:
a request to include trigger-related indications with or in RVQoE reports; and
an RVQoE reporting configuration comprising the at least one event or condition.

45. The method of claim 37, wherein detecting the occurrence of the at least one event or condition comprises receiving from the RAN node an indication that the at least one event or condition has occurred.

46. A method for a radio access network (RAN) node configured to manage quality-of-experience (QoE) measurements by user equipment (UEs) in the RAN, the method comprising:
sending, to a UE, a RAN-visible QoE (RVQoE) reporting request that includes one or more of the following:
a request to include trigger-related indications with or in RVQoE reports, and
a reporting configuration comprising at least one event or condition that triggers an RVQoE report; and
based on occurrence of the at least one event or condition, receiving the following from the UE:
at least one RVQoE report that includes one or more RVQoE metrics or RVQoE values, wherein each RVQoE metric or RVQoE value is based on QoE measurements performed by the UE; and
one or more trigger-related indications associated with the at least one event or condition, included in or with each RVQoE report received.

47. The method of claim 46, wherein the one or more trigger-related indications include any of the following:
indication that an RVQoE reporting trigger occurred;
indication or identifier of the RVQoE reporting trigger;
a time at which the RVQoE reporting trigger occurred;
cause or reason for occurrence of the RVQoE reporting trigger;
indication or identifier of entity that detected the RVQoE reporting trigger;
type of RVQoE reporting trigger; and
extended information associated with the RVQoE reporting trigger.

48. The method of claim 47, wherein the extended information includes one or more of the following: cell identifier; network slice identifier; network slice type; radio access technology (RAT) identifier; public land mobile network (PLMN) identifier; protocol data unit (PDU) session-related parameters; and respective values of one or more QoE-related parameters that caused the RVQoE reporting trigger.

49. The method of claim 46, wherein the at least one event or condition is related to one or more of the following:
an RVQoE reporting request sent to the UE;
a duration since last RVQoE report;
an RVQoE reporting configuration sent to the UE;
messages or control elements (CEs) sent to or received from the UE;
messages sent between different units of the RAN node;
one or more RAN-related events;
a UE procedure related to mobility, multi-connectivity, and/or Radio Resource Control (RRC) state change;
a protocol data unit (PDU) session;
a network slice;
layer-2 and/or radio-related measurements performed by the UE;
one or more RVQoE metrics and/or RVQoE values in relation to corresponding thresholds;
service types, service subtypes, and/or subservice types of the one or more applications being measured; and
session-related events for the one or more applications being measured.

50. The method of claim 46, further comprising:
detecting the occurrence of the at least one event or condition; and
sending to the UE an indication that the at least one event or condition has occurred,
wherein the at least one RVQoE report is received in response to sending the indication.

51. The method of claim 50, wherein:
the occurrence of the at least one event or condition is detected by a first unit of the RAN node;
the indication is sent to the UE by a second unit of the RAN node; and
detecting the occurrence of the at least one event or condition comprises receiving, by the second unit from the first unit, the indication that the at least one event or condition has occurred.

52. The method of claim 51, further comprising sending, by the second unit to the first unit, an RVQoE reporting configuration comprising the at least one event or condition.

53. The method of claim 51, wherein the second unit is a centralized unit control plane (CU-CP) and one of the following applies:
the first unit is a distributed unit (DU) and the indication sent by the first unit is an F1AP message; or
the first unit is a centralized unit user plane (CU-UP) and the indication sent by the first unit is an E1AP message.

54. The method of claim 46, further comprising performing one or more of the following based on the received at least one RVQoE report:
managing carrier aggregation (CA) and/or dual connectivity (DC) for the UE;
scheduling and/or link adaptation for data associated with a UE application;
selecting a type of handover or other mobility operation to be performed by the UE;
evaluating a handover or other mobility operation previously performed by the UE; and
training one or more artificial intelligence/machine learning (AI/ML) models.

55. User equipment (UE) configured to perform quality-of-experience (QoE) measurements in a radio access network (RAN), the UE comprising:
communication interface circuitry configured to communicate with a RAN node; and
processing circuitry operatively coupled to the radio transceiver circuitry, wherein the processing circuitry and the communication interface circuitry are configured to:
perform QoE measurements for one or more applications operating on a UE application layer;
detect occurrence of at least one event or condition that triggers a RAN-visible QoE (RVQoE) report; and
based on detecting the occurrence of the at least one event or condition, send the following to the RAN node:
at least one RVQoE report that includes one or more RVQoE metrics or RVQoE values, wherein each RVQoE metric or RVQoE value is based on the QoE measurements performed; and
one or more trigger-related indications associated with the detected event or condition, included in or with each RVQoE report sent.

56. A radio access network (RAN), node configured to manage quality-of-experience (QoE) measurements by user equipment (UEs) in the RAN, the RAN node comprising:
communication interface circuitry configured to communicate with UEs and with one or more other RAN nodes; and
processing circuitry operatively coupled to the communication interface circuitry, whereby the processing circuitry and the communication interface circuitry are configured to perform the method of claim 46.
